(19) United States
(12) Patent Application Publication
(10) Pub. No.: US 2026/0166881 A1
(43) Pub. Date: Jun. 18, 2026

(54) LIQUID DISCHARGE HEAD AND LIQUID DISCHARGE APPARATUS

(71) Applicants: Toshiaki MASUDA, Kanagawa (JP); Yu WATANABE, Kanagawa (JP); Keishi MIWA, Kanagawa (JP)

(72) Inventors: Toshiaki MASUDA, Kanagawa (JP); Yu WATANABE, Kanagawa (JP); Keishi MIWA, Kanagawa (JP)

(21) Appl. No.: 19/398,096

(22) Filed: Nov. 24, 2025

(30) Foreign Application Priority Data
Dec. 12, 2024 (JP) 2024-218079
Aug. 21, 2025 (JP) 2025-138518

(51) Int. Cl. B41J 2/16; B41J 2/045; B41J 2/14

(52) U.S. Cl. CPC B41J 2/1623; B41J 2/04563; B41J 2/14233; B41J 2/161; B41J 2/04581; B41J 2202/11

(57) ABSTRACT

A liquid discharge head includes an actuator component and a frame. The actuator component includes a nozzle substrate and an actuator substrate. The nozzle substrate has nozzles arrayed in a longitudinal direction of the nozzle substrate. The actuator substrate includes a chamber substrate, a diaphragm, and a piezoelectric element. The chamber substrate has pressure chambers respectively communicating with the nozzles. The diaphragm has a first face serving as a part of a wall face of the pressure chambers and a second face opposite the first face. The piezoelectric element is disposed over the second face of the diaphragm, to discharge a liquid in the pressure chambers from the nozzles in a discharge direction orthogonal to the longitudinal direction. The frame has a bonding face bonded to the actuator component with an adhesive, communicating portions communicating with the pressure chambers, and multiple void portions.

### CROSS-REFERENCE TO RELATED APPLICATIONS

This patent application is based on and claims priority pursuant to 35 U.S.C. § 119(a) to Japanese Patent Application Nos. 2024-218079, filed on Dec. 12, 2024, and 2025-138518, filed on Aug. 21, 2025, in the Japan Patent Office, the entire disclosure of each of which is hereby incorporated by reference herein.

### BACKGROUND

### Technical Field

The present disclosure relates to a liquid discharge head and a liquid discharge apparatus.

### Related Art

In the related art, a liquid discharge head includes an actuator substrate and a reinforcing member. The actuator substrate includes a diaphragm and a piezoelectric element. The diaphragm is laminated on a substrate having liquid chambers communicating with nozzles and forms part of a wall face of the liquid chambers. The piezoelectric element is laminated on a face of the diaphragm on a side opposite a side forming the wall face of the liquid chambers. The reinforcing member has communicating portions communicating with the liquid chambers. The reinforcing member is bonded to a substrate component with an adhesive.

### SUMMARY

The present disclosure described herein provides an improved liquid discharge head including an actuator component and a frame. The actuator component includes a nozzle substrate and an actuator substrate. The nozzle substrate has nozzles arrayed in a longitudinal direction of the nozzle substrate. The actuator substrate includes a chamber substrate, a diaphragm, and a piezoelectric element. The chamber substrate is disposed over the nozzle substrate. The chamber substrate has pressure chambers respectively communicating with the nozzles. The diaphragm is disposed over the chamber substrate. The diaphragm has a first face serving as a part of a wall face of the pressure chambers and a second face opposite the first face. The piezoelectric element is disposed over the second face of the diaphragm, to discharge a liquid in the pressure chambers from the nozzles in a discharge direction orthogonal to the longitudinal direction. The frame has a bonding face bonded to the actuator component with an adhesive, communicating portions communicating with the pressure chambers, and multiple void portions.

Further, the present disclosure described herein provides an improved liquid discharge head including an actuator component and a frame. The actuator component includes a nozzle substrate and an actuator substrate. The nozzle substrate has nozzles arrayed in a longitudinal direction of the nozzle substrate. The actuator substrate includes a chamber substrate, a diaphragm, and a piezoelectric element. The chamber substrate is disposed over the nozzle substrate. The chamber substrate has pressure chambers respectively communicating with the nozzles. The diaphragm is disposed over the chamber substrate. The diaphragm has a first face serving as a part of a wall face of the pressure chambers and a second face opposite the first face. The piezoelectric element is disposed over the second face of the diaphragm, to discharge a liquid in the pressure chambers from the nozzles in a discharge direction orthogonal to the longitudinal direction. The frame has a bonding face bonded to the actuator component with an adhesive, communicating portions communicating with the pressure chambers, and a void portion including a recess (or including a closed space).

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic view of a part of a liquid discharge head;

FIG. 2 is a schematic view of an actuator substrate including an upper electrode as a common electrode and lower electrodes as individual electrodes;

FIG. 3 is a schematic view of a liquid discharge head according to a comparative example;

FIG. 4 is a schematic view of a liquid discharge head according to a first example of the present disclosure;

FIG. 5 is a schematic view of a liquid discharge head according to a second example of the present disclosure;

FIG. 6 is a graph illustrating compressive stress applied, at positions in a longitudinal direction of the liquid discharge head, to an actuator substrate according to the comparative example, the first example, and the second example;

FIG. 7 is a schematic view of a piezoelectric element wafer;

FIGS. 8A to 8C are graphs illustrating average discharge speed distributions of actuator substrates at positions on the piezoelectric element wafer of FIG. 7;

FIGS. 9A to 9C are schematic views of a liquid discharge head according to a third example of the present disclosure;

FIG. 10A is a graph illustrating average discharge speed distribution of an actuator substrate;

FIG. 10B is a graph illustrating average discharge speed distribution of the actuator substrate of FIG. 10A after a frame having a void portion has been bonded;

FIG. 11A is a schematic view of a liquid discharge head according to a first modification of the third example of FIGS. 9A to 9C, illustrating a void portion in a frame;

FIG. 11B is a graph illustrating average discharge speed distribution of the first modification;

FIG. 12A is a schematic view of a liquid discharge head according to a second modification of the third example of FIGS. 9A to 9C, illustrating void portions in a frame;

FIG. 12B is a graph illustrating average discharge speed distribution of the second modification;

FIG. 13A is a schematic view of a liquid discharge head according to a third modification of the third example of FIGS. 9A to 9C, illustrating a void portion in a frame;

FIG. 13B is a graph illustrating average discharge speed distribution of the third modification;

FIG. 14A is a schematic view of a liquid discharge head according to a fourth modification of the third example of FIGS. 9A to 9C, illustrating a void portion in a frame;

FIG. 14B is a graph illustrating average discharge speed distribution of the fourth modification;

FIG. 15 is a side view of a mechanism section of an inkjet recording apparatus;

FIG. 16 is a schematic view of a printer as another inkjet recording apparatus;

FIG. 17 is a plan view of a head unit of the printer of FIG. 16;

FIG. 18 is a plan view of a part of yet another inkjet recording apparatus;

FIG. 19 is a side view of the part of the inkjet recording apparatus of FIG. 18;

FIG. 20 is a plan view of a part of a liquid discharge unit; and

FIG. 21 is a front view of another liquid discharge unit.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

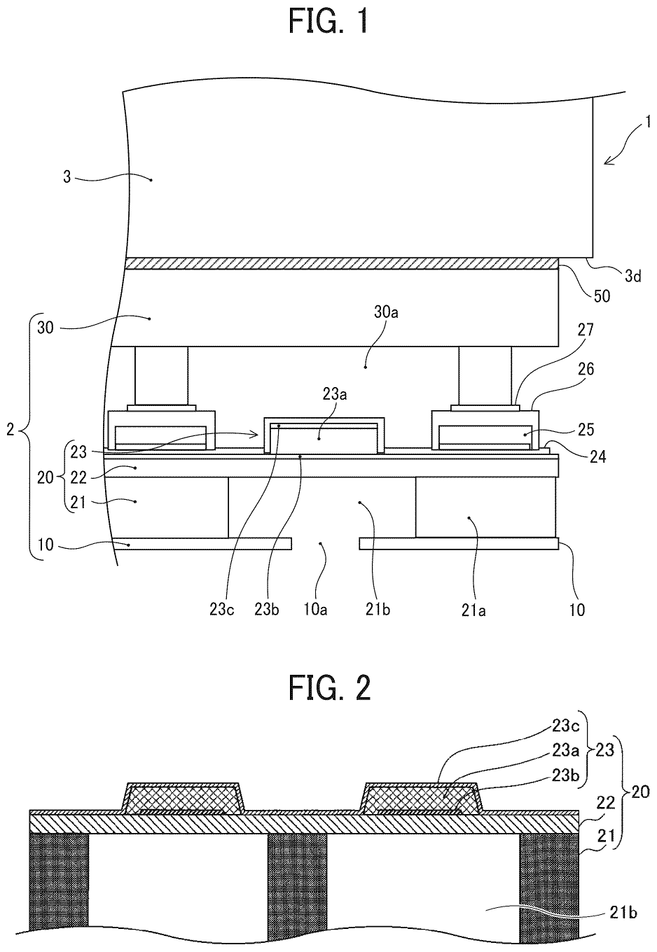

Embodiments of the present disclosure will be described below with reference to the drawings. FIG. 1 is a schematic view of a part of a liquid discharge head 1, i.e., a cross-sectional view in a transverse direction of the liquid discharge head 1.

The liquid discharge head 1 includes an actuator component 2 serving as a substrate component and a frame 3 serving as a reinforcing member bonded to the actuator component 2 with an adhesive 50. The actuator component 2 includes a nozzle substrate 10, an actuator substrate 20, and a support substrate 30. The actuator component 2 is formed by joining the actuator substrate 20, the support substrate 30, and the nozzle substrate 10 to each other.

The nozzle substrate 10 is formed with multiple nozzle holes 10a (i.e., nozzles) to discharge a liquid. The multiple nozzle holes 10a are arrayed in a longitudinal direction orthogonal to the transverse direction (i.e., the longitudinal direction of the nozzle substrate 10). The liquid is discharged from the multiple nozzle holes 10a in a discharge direction orthogonal to the longitudinal direction and the transverse direction. The actuator substrate 20 includes a pressure chamber substrate 21, a diaphragm 22, and a piezoelectric element 23 that generates energy for discharging the liquid. The pressure chamber substrate 21 may be referred to simply as a chamber substrate. The pressure chamber substrate 21 has pressure chambers 21b (individual liquid chambers) as multiple liquid chambers respectively communicating with the multiple nozzle holes 10a and includes pressure chamber partitions 21a that partition the pressure chambers 21b. The pressure chamber substrate 21 further has individual channels respectively communicating with the pressure chambers 21b. The pressure chambers 21b are each defined by the diaphragm 22 of the actuator substrate 20, the nozzle substrate 10, and the pressure chamber partitions 21a of the pressure chamber substrate 21.

The diaphragm 22 has a first face opposed to a nozzle forming wall of the nozzle substrate 10 across the pressure chambers 21b and a second face opposite the first face. The nozzle holes 10a are arrayed on the nozzle forming wall in the longitudinal direction of the nozzle substrate 10. The piezoelectric element 23 is disposed on the second face of the diaphragm 22 to form a deformable wall.

The pressure chamber substrate 21 and the diaphragm 22 are integrally formed of a like material using a silicon on insulator (SOI) substrate. In other words, the SOI substrate includes a silicon oxide film, a silicon layer, and a silicon oxide film on a silicon substrate in this order. The silicon substrate serves as the pressure chamber substrate 21, and the diaphragm 22 is formed of the silicon oxide film, the silicon layer, and the silicon oxide film. In this configuration, the layer structure of the silicon oxide film, the silicon layer, and the silicon oxide film of the SOI substrate serves as the diaphragm 22. As described above, the diaphragm 22 includes materials formed on a surface of the pressure chamber substrate 21. The pressure chamber substrate 21 and the diaphragm 22 may be separately formed of different materials.

The piezoelectric element 23 includes a piezoelectric body 23a, a common electrode 23b (may be referred to as a lower electrode), and an individual electrode 23c (may be referred to as an upper electrode). The piezoelectric body 23a is sandwiched between the common electrode 23b and the individual electrode 23c. The piezoelectric element 23 is covered with an insulating film 24. Lead wires 25 respectively extended from the common electrode 23b and the individual electrode 23c are formed on the insulating film 24. The lead wires 25 are electrically connected to a drive controller of an external device, which applies a voltage to the common electrode 23b and the individual electrodes 23c, via connectors disposed at an end of the liquid discharge head 1. The lead wires 25 are coated with a passivation film 26.

The support substrate 30 is bonded to the actuator substrate 20 with an adhesive 27. The support substrate 30 has a common liquid chamber communicating with the individual channels and a void portion 30a (counterbore). The void portion 30a allows the wall of the pressure chambers 21b of the diaphragm 22 to deform. The piezoelectric element 23 is disposed in the void portion 30a. The support substrate 30 covers the piezoelectric element 23.

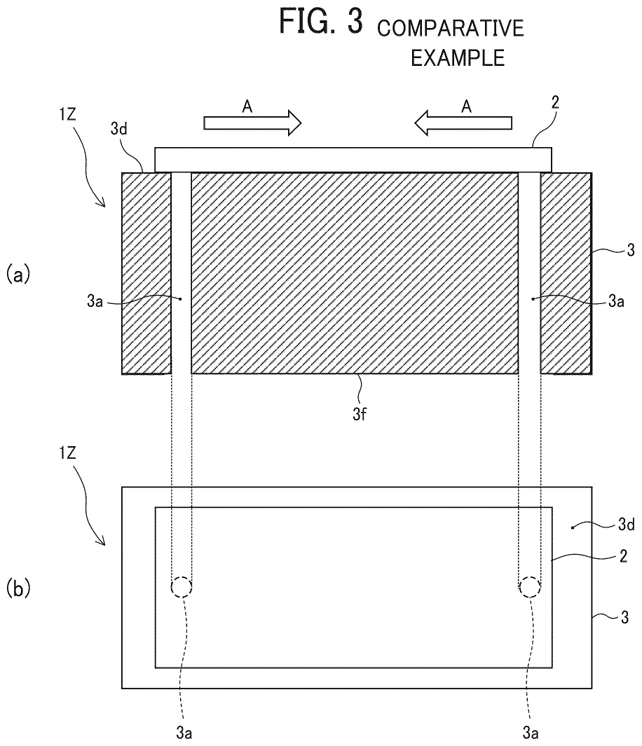

The frame 3 is bonded to the support substrate 30 with the adhesive 50 that is a thermosetting type. The frame 3 as the reinforcing member reinforces the actuator component 2 to prevent the deformation of the actuator component 2 due to an external force. The frame 3 has communicating holes 3a (see FIG. 3 and other drawings) serving as communicating portions communicating with the common liquid chamber formed in the support substrate 30. The communication holes 3a penetrate through the frame 3. The common liquid chamber is connected to an external liquid tank via the communicating holes 3a to supply and collect the liquid to and from the pressure chambers 21b.

The actuator component 2 may include a damper substrate laminated over the support substrate 30. The damper substrate includes a damper and a damper holder holding the damper. The damper forms a deformable wall of the common liquid chamber in the support substrate 30. The damper is formed of, for example, a palladium-nickel alloy (PdNi). The damper holder is formed of, for example, silicon (Si). The damper holder has a recess facing the wall of the common liquid chamber to allow the wall of the common liquid chamber to deform.

The damper substrate reduces an influence (for example, crosstalk) on the liquid discharge from one nozzle hole among the nozzle holes 10a via the common liquid chamber caused by pressure fluctuation generated when the liquid is discharged from another nozzle hole. Specifically, as the damper substrate appropriately exerts a damper function, the damper substrate prevents crosstalk to stabilize liquid discharge accuracy from each nozzle. In the crosstalk, vibration (pressure fluctuation) when the liquid is discharged from one nozzle propagates via the liquid in the common liquid chamber and affects the liquid discharge from an adjacent nozzle.

In the liquid discharge head 1, when the pressure chambers 21b are filled with the liquid such as a recording liquid (ink), a pulse voltage based on image data is applied from an oscillation circuit of the drive controller to the individual electrode 23c corresponding to the nozzle hole 10a, from which the recording liquid is to be discharged, via the lead wires 25. As the pulse voltage is applied to the piezoelectric body 23a, the piezoelectric body 23a expands in a direction orthogonal to the diaphragm 22 due to an electrostrictive effect, causing the diaphragm 22 to be displaced. As a result, pressure in the pressure chamber 21b increases to discharge the recording liquid from the nozzle hole 10a communicating with the pressure chamber 21b. After the pulse voltage is applied, the piezoelectric body 23a that has been expanded returns to the original shape. Accordingly, the diaphragm 22 that has been bent returns to the original position. Thus, the pressure of the recording liquid in the pressure chamber 21b is less than that in the common liquid chamber, so that the recording liquid is supplied from the common liquid chamber to the pressure chamber 21b. The recording liquid is supplied from the external liquid tank to the common liquid chamber in the support substrate 30 via the communicating holes 3a (see FIG. 3 and other drawings) of the frame 3. As such expansion and contraction of the piezoelectric body 23a are repeated, liquid droplets can be continuously discharged to form an image on a recording medium (sheet) facing the liquid discharge head 1.

A manufacturing process of the liquid discharge head 1 will be described below. First, the diaphragm 22 is formed on the pressure chamber substrate 21 including a monocrystalline silicon substrate (with a plate thickness of 400 μm or 600 μm, for example) having (110) plane orientation. The diaphragm 22 has a structure in which a silicon oxide film and a silicon nitride film are laminated as materials, for example, by low-pressure chemical vapor deposition (LP-CVD). As materials for the diaphragm 3, other materials such as silicon and zircon oxide may be used, or other elements may be doped for stress control. An active layer of a silicon on insulator (SOI) wafer may be used instead of the monocrystalline silicon substrate. The plane orientation of silicon of the pressure chamber substrate 21 is not limited to (110) plane orientation, and thus, preferably, a plane orientation suitable for flow in a subsequent process may be selected.

Subsequently, the common electrode 23b including a platinum (Pt) layer with a layer thickness of 150 nm and a titanium oxide (TiO₂) layer with a layer thickness of 40 nm is formed by sputtering. A film of lead zirconate titanate (PZT) is repeatedly formed multiple times by, for example, a sol-gel method using spin coating to finally form the piezoelectric body 23a with a film thickness of 2 μm. Specifically, lead zirconate titanate (PZT) is applied onto the top of the common electrode 23b by spin coating, and firing is performed. At this time, the firing to be performed is divided into, for example, three steps of drying (at 120° C.), calcining (at 380° C.), and firing (at 700° C.). Thus, the piezoelectric body 23a on the common electrode 23b can have favorable crystallinity with PZT having (100) plane orientation. The film formation for the piezoelectric body 23a is not limited to the sol-gel method using spin coating. The piezoelectric body 23a may be formed by using, for example, sputtering, ion plating, an aerosol method, or an inkjet method.

The individual electrode 23c including strontium ruthenate (SRO) with a film thickness of 40 nm and platinum (Pt) with a film thickness of 100 nm is formed by sputtering. As the materials for the individual electrode 23c, for example, titanium (Ti), gold (Au), or copper (Cu) may be used. The piezoelectric body 23a and the individual electrode 23c are formed, by lithography etching, at the position corresponding to the pressure chamber 21b to be formed later.

After the insulating film 24 is formed, holes for connecting the lead wire 25 and the common electrode 23b and connecting the lead wire 25 and the individual electrode 23c are formed in the insulating film 24 by photolithography and etching. Then, as the lead wires 25, for example, titanium nitride (TiN) with a film thickness of 30 nm and aluminum (Al) with a film thickness of 3 μm are formed by sputtering. Films of titanium nitride (TiN) are respectively formed in the holes of the insulating film 24 described above to serve as the connector to the common electrode 23b and the connector to the individual electrode 23c. A film of aluminum (Al) is formed on the insulating film 24.

The connector between the lead wire 25 and the common electrode 23b and the connector between the lead wire 25 and the individual electrode 23c are formed of titanium nitride (TiN) for the following reasons. When Pt as the material for the individual electrode 23c or the common electrode 23b is in direct contact with Al as the material for the lead wire 25, an alloy may be formed due to thermal histories in subsequent steps, leading to, for example, film peeling due to stress caused by a volume change. As described above, the connector between the lead wire 25 and the common electrode 23b and the connector between the lead wire 25 and the individual electrode 23c are formed of titanium nitride (TiN), and thus titanium nitride (TiN) functions as barrier layers that prevent alloying. Preferably, a low-resistance material is used for the lead wire 25. A material containing gold (Au), nickel (Ni), or chromium (Cr) may be used to form the lead wire 25. In FIG. 1, the individual electrode 23c is the upper electrode laminated on the piezoelectric body 23a, and the common electrode 23b is the lower electrode on which the piezoelectric body 23a is laminated. However, as illustrated in FIG. 2, the upper electrode may function as the common electrode, and the lower electrode may function as the individual electrode.

After the passivation film 26 is formed, the void portion 30a (counterbore) is formed at the position corresponding to the piezoelectric element 23 by lithography etching to manufacture the support substrate 30. At this time, silicon (Si) processing is performed by dry etching. After that, the support substrate 30 and the portion of the actuator substrate 20, where the passivation film 26 is formed, are bonded to each other with the adhesive 27. At this time, the support substrate 30 is coated with the adhesive 27 having a thickness of approximately 1 μm by a typical thin-film transfer device. After that, the pressure chamber substrate 21 is polished by a commonly used technique so as to have a desired thickness (e.g., a thickness of 80 μm) to form the pressure chamber 21b. Instead of polishing, for example, etching may be used.

Subsequently, the surface of the pressure chamber substrate 21, to which the nozzle substrate 10 is to be joined, is covered with a resist by lithography. After that, the pressure chamber 21b is formed in the pressure chamber substrate 21 by anisotropic wet etching with an alkaline solution, such as potassium hydroxide (KOH) solution or tetramethyl ammonium hydroxide (TMAH) solution. The pressure chambers 21b may be formed by dry etching using an inductively coupled plasma (ICP) etcher, instead of the anisotropic etching using an alkaline solution.

Then, the nozzle substrate 10 having the nozzle holes 10a is joined to the pressure chamber substrate 21 such that the nozzle holes 10a are respectively located at the positions corresponding to the pressure chambers 21b, which are formed separately. The actuator component 2 is formed by the above-described processes.

The frame 3 made of a glass epoxy resin is bonded, with the adhesive 50 that is the thermosetting type, to one face of the support substrate 30 opposite the other face to which the actuator substrate 20 is bonded. The frame 3 has the communicating holes 3a (see FIG. 3 and other drawings) for introducing the recording liquid (ink) into the common liquid chamber in the support substrate 30. The adhesive 50 that is the thermosetting type is applied onto a bonding face 3d of the frame 3. The adhesive 50 is heated and cured while pressure is applied from above and below to bond the frame 3 to the support substrate 30. The adhesive 50 is heated to 100° C. and cured to further enhance ink resistance. Thus, the liquid discharge head 1 is completed.

The material for the frame 3 is not limited to the glass epoxy resin. When the adhesive 50 is heated and cured for bonding, a material with a small difference in thermal expansion coefficient from silicon is preferably used as the material for the frame. Silicon is used as the base material for the actuator component 2.

### Comparative Example

FIG. 3 is a schematic view of a liquid discharge head 1Z according to a comparative example. A part (1) of FIG. 3 illustrates a cross-sectional view. A part (b) of FIG. 3 illustrates a schematic view as viewed from a liquid discharge side.

In the liquid discharge head 1Z according to the comparative example, as illustrated in FIG. 3, the frame 3 has no void portion other than the communicating holes 3a for supplying the recording liquid to the common liquid chamber formed in the support substrate 30. Accordingly, the frame 3 has a large volume.

When the actuator component 2 and the frame 3 are bonded to each other, as described above, the adhesive 50 that is the thermosetting type is applied onto the bonding face 3d of the frame 3. Then, the adhesive 50 is heated and cured while pressure is applied to the frame 3 and the actuator component 2 from above and below.

After the adhesive 50 that is the thermosetting type is cured, and the actuator component 2 and the frame 3 are bonded to each other, the actuator component 2 and the frame 3 are thermally contracted when the actuator component 2 and the frame 3 return to a room temperature. A linear expansion coefficient of the frame 3 including the resin is larger than a linear expansion coefficient of the actuator component 2 including the silicon substrate. As a result, an amount of thermal contraction of the frame 3 is larger than that of the actuator component 2. The actuator component 2 receives stress (may be referred to as thermal stress) in the directions indicated by arrows A in FIG. 3 at a bonded interface due to a difference in the amount of thermal contraction with respect to the frame 3.

In the comparative example, the frame 3 has the communicating holes 3a (i.e., the communicating portions) serving as void portions and does not have other void portions other than the communicating holes 3a. Accordingly, the frame 3 has a large volume, and the amount of thermal contraction of the frame 3 is large when the frame 3 returns to the room temperature after the adhesive 50 is thermally cured. As a result, the difference in the amount of thermal contraction between the frame 3 and the actuator component 2 increases, increasing the thermal stress applied to the actuator component 2.

The thermal stress applied in the directions indicated by arrows A illustrated in FIG. 3 changes the rigidity of a pressurizing portion formed by the diaphragm 22 and the piezoelectric element 23 that pressurizes the pressure chamber 21b. In the liquid discharge head 1 (e.g., the liquid discharge head 1Z), the pulse voltage (power waveform) to be applied to the piezoelectric element 23 is set based on a resonance frequency determined from, for example, the dimensions of the pressurizing portion described above and the pressure chamber 21b, the dimension between the pressure chamber 21b and the common liquid chamber, and the recording liquid (ink) to be used. As the rigidity of the pressurizing portion changes, the resonance frequency changes. As a result, desired discharge characteristics may not be obtained. The thermal stress described above may cause the warpage of the actuator component 2. As warpage occurs in the actuator component 2, discharge directions of the liquid discharged from the nozzle holes 10a may vary.

### First Example

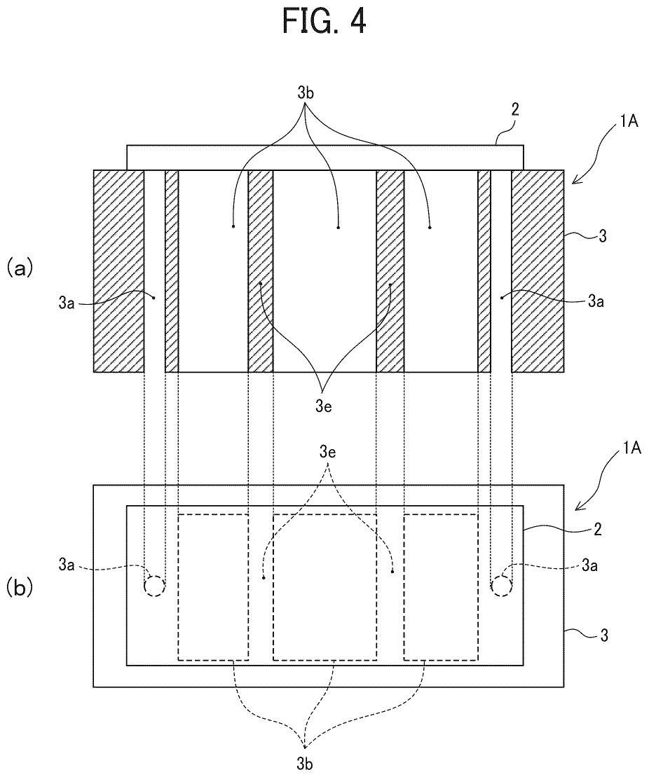

FIG. 4 is a schematic view of a liquid discharge head 1A according to a first example. A part (a) of FIG. 4 illustrates a cross-sectional view. A part (b) of FIG. 4 illustrates a schematic view as viewed from a liquid discharge side.

As illustrated in FIG. 4, a liquid discharge head 1A according to the first example has multiple void portions 3b, which are three through holes penetrating through the frame 3, in addition to the communicating holes 3a in the frame 3.

Accordingly, the volume of the frame 3 is reduced as compared with the configuration of the comparative example illustrated in FIG. 3, and the amount of thermal contraction of the frame 3 is reduced when the frame 3 returns to the room temperature after the adhesive 50 is thermally cured. As a result, a difference in the amount of thermal contraction between the frame 3 and the actuator component 2 is reduced as compared with that in the comparative example, and thus the thermal stress applied to the actuator component 2 is reduced.

In the first example, partitions 3e extend in the transverse direction of the liquid discharge head 1 to partition the void portions 3b, and thus the multiple void portions 3b are arranged in the longitudinal direction of the liquid discharge head 1.

For example, the frame 3 may have a frame structure surrounding one large rectangular through hole at the center to further reduce the volume of the frame 3. In such a case, the thermal stress applied to the actuator component 2 is further reduced. However, when the frame 3 has such a frame structure, the rigidity of the frame 3 may be lowered. As a result, the frame 3 may not exert the original function of reinforcing the actuator component 2 to prevent the deformation of the actuator component 2 due to, for example, an external force.

As described above, in the first example, the partitions 3e extend in the transverse direction of the liquid discharge head 1A to partition the void portions 3b, and the multiple void portions 3b are arranged in the longitudinal direction of the liquid discharge head 1A. Due to such a configuration, the partitions 3e reinforce the frame 3 to prevent the rigidity of the frame 3 from being lowered. Accordingly, the frame 3 satisfactorily reinforces the actuator component 2 to prevent the deformation of the actuator component 2 due to, for example, an external force.

In the first example, the multiple void portions 3b are arranged in the longitudinal direction of the liquid discharge head, but partitions may extend in the longitudinal direction to partition the void portions 3b, and the multiple void portions 3b may be arranged in the transverse direction. However, the multiple void portions 3b arranged in the longitudinal direction as in the first example are preferable as compared with the multiple void portions 3b arranged in the transverse direction. When the partitions have the same thickness, the volume of the frame 3 having the multiple void portions arranged in the longitudinal direction is smaller than the volume of the frame 3 having the multiple void portions arranged in the transverse direction. The multiple void portions arranged in the longitudinal direction reduce the volume of the frame 3 compared to the multiple void portions arranged in the transverse direction while maintaining the rigidity of the frame 3. Accordingly, the multiple void portions arranged in the longitudinal direction reduce the thermal stress applied to the actuator component 2 compared to the multiple void portions arranged in the transverse direction.

Examples of each of the multiple void portions 3b in the frame 3 includes a closed void portion having no opening (i.e., a void portion including a closed space), a void portion having a recess in cross section, which is opened only on a face 3f opposite the bonding face 3d, and a void portion having a recess in cross section, which is opened only on the bonding face 3d in addition to the through hole (i.e., a through void portion). The multiple void portions may not each have the same shape. The void portions (e.g., the through void portion, the closed void portion, the void portion opened only on the face 3f opposite to the bonding face 3d, and the void portion opened only on the bonding face 3d) described above may be appropriately combined with each other.

Preferably, the multiple void portions have openings on the bonding face 3d. The multiple void portions having the openings on the bonding face 3d reduce the volume of a portion of the frame 3 on the bonding face 3d side and reduce the amount of thermal contraction on the bonding face 3d side. Accordingly, the thermal stress applied to the actuator component 2 via the bonding face 3d is reduced to reduce a change in the rigidity of the pressurizing portion formed by the diaphragm 22 and the piezoelectric element 23 that pressurize the pressure chamber 21b.

### Second Example

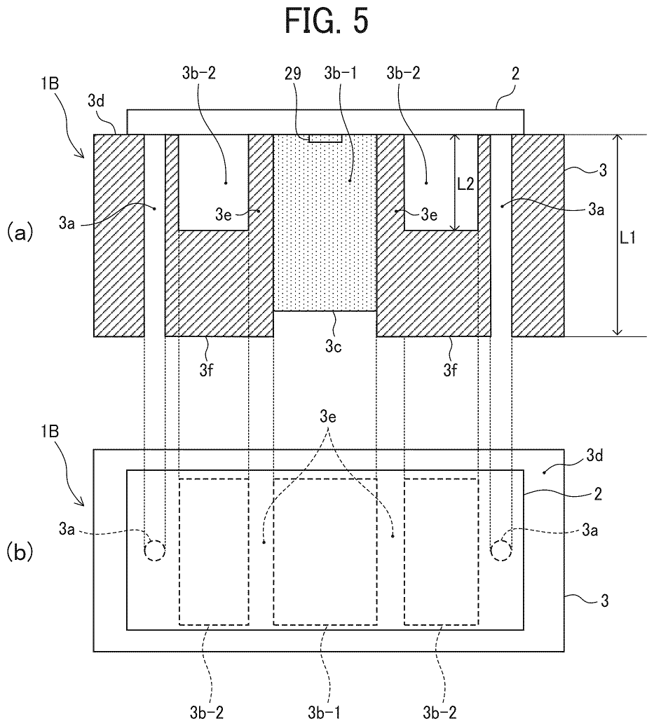

FIG. 5 is a schematic view of a liquid discharge head 1B according to a second example. A part (a) of FIG. 5 illustrates cross-sectional view. A part (b) of FIG. 5 illustrates a schematic view as viewed from a liquid discharge side.

In the liquid discharge head 1B according to the second example, a through void portion 3b-1 penetrating through the frame 3 is disposed at the center in the longitudinal direction and void portions 3b-2 each having a recess opened only on the bonding face 3d are disposed on both sides of the frame 3 in the longitudinal direction. In other words, the recess of the void portion 3b-2 is recessed from the bonding face 3d. The configuration including the void portions 3b-2 each having the recess opened only on the bonding face 3d increases the rigidity of the frame 3 compared to the first example in which the multiple void portions are all through void portions penetrating through the frame 3. As described above, the through void portion 3b-1 is disposed at the center in the longitudinal direction, and the void portions 3b-2 each having the recess in cross section, which is opened only on the bonding face 3d, are disposed on both sides of the through void portion 3b-1 in the longitudinal direction. Accordingly, the frame 3 has well-balanced rigidity. Also in the second example, all the three void portions 3b-1 and 3b-2 are opened on the actuator component 2 side. Thus, as described above, the amount of thermal contraction on the bonding face 3d side of the frame 3 is reduced, and the thermal stress applied to the actuator component 2 is reduced.

In the configuration of the second example, a thermistor 29 as an electric component is inserted into the through void portion 3b-1. The thermistor 29 is attached to the actuator component 2 so as to face the through void portion 3b-1. The thermistor 29 is temperature measuring device that measures a temperature of the actuator component 2. The through void portion 3b-1 is filled with a sealant 3c to seal the thermistor 29 to protect the thermistor 29 from, for example, moisture.

The sealant 3c is, for example, an ultraviolet (UV) curable resin. After the through void portion 3b-1 is filled with sealant 3c, the sealant 3c is irradiated with UV rays from the opening of the through void portion 3b-1 on the face 3f side opposite the bonding face 3d to cure the sealant 3c. In the second example, the UV curable resin having low UV transmittance is used. Accordingly, UV rays penetrate the sealant 3c to a certain depth. As a result, the sealant 3c is uncured on the actuator component 2 side. In other words, the sealant 3c adjacent to the actuator component 2 is uncured.

The sealant 3c on the side opposite the actuator component 2 side is cured, and thus the thermistor 29 is sealed with the cured resin. Since the sealant 3c on the actuator component 2 side is uncured, stress due to contraction of the cured sealant 3c on the actuator component 2 side is unlikely to be applied to the actuator component 2. Accordingly, a change in the rigidity of the pressurizing portion formed by the diaphragm 22 and the piezoelectric element 23 that pressurize the pressure chamber 21b of the actuator component 2 is reduced to reduce an influence on the discharging performance.

On the other hand, the frame 3 on the side opposite the actuator component 2 side receives the influence of contraction of the cured sealant 3c. However, the void portions 3b-2 are disposed on both sides of the through void portion 3b-1 filled with the sealant 3c in the longitudinal direction. The void portions 3b-2 each includes a recess in cross section, opened on the actuator component 2 side, and the recess is closed on the side opposite the actuator component 2 side. Accordingly, the frame 3 has high rigidity on the side opposite the actuator component 2 side. Thus, the frame 3 does not deform due to contraction of the cured sealant 3c on the side opposite to the actuator component 2 side. As a result, a change in the rigidity of the pressurizing portion due to an influence of the deformation of the frame 3 is reduced to reduce an influence on the discharging performance.

A depth L2 of each of the void portions 3b-2 each including the recess in cross section, which are disposed on both sides of the through void portion 3b-1 in the longitudinal direction, is set to (½) of a length L1 of the frame 3 in a liquid discharge direction (may be referred to simply as a discharge direction). The liquid discharge direction is orthogonal to both the transverse direction and the longitudinal direction of the liquid discharge head, i.e., a direction of lamination of components. To reduce thermal contraction of the frame 3 on the bonding face 3d side to prevent the deterioration in the discharging performance of the actuator component 2 due to thermal stress, the depth L2 is preferably set to at least (⅓) of the length L1 or more.

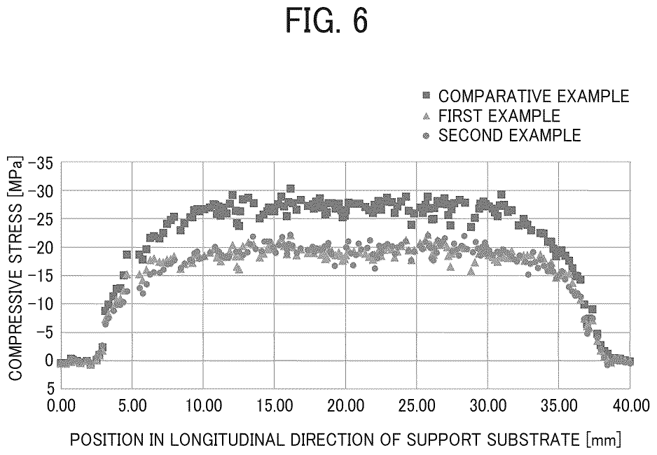

FIG. 6 is a graph illustrating compressive stress applied, at positions in the longitudinal direction of the liquid discharge head, to the actuator components 2 according to the comparative example, the first example, and the second example. The compressive stress illustrated in FIG. 6 indicates a result acquired by simulating a bonding process of the frame 3 to the actuator component 2, in each of the comparative example, the first example, and the second example, using simulation software available from ANSYS® (part of Synopsys®).

As illustrated in FIG. 6, the frame 3 having the multiple void portions other than the communicating holes 3a as in the first and second examples reduces the compressive stress by approximately half, as compared with the frame 3 having no void portion other than the communicating holes 3a as in the comparative example. In the first and second examples, the liquid discharge head can reduce a change in the rigidity of the pressurizing portion formed by the diaphragm 22 and the piezoelectric element 23 to prevent the deterioration in the discharging performance, as compared with the comparative example.

### Third Example

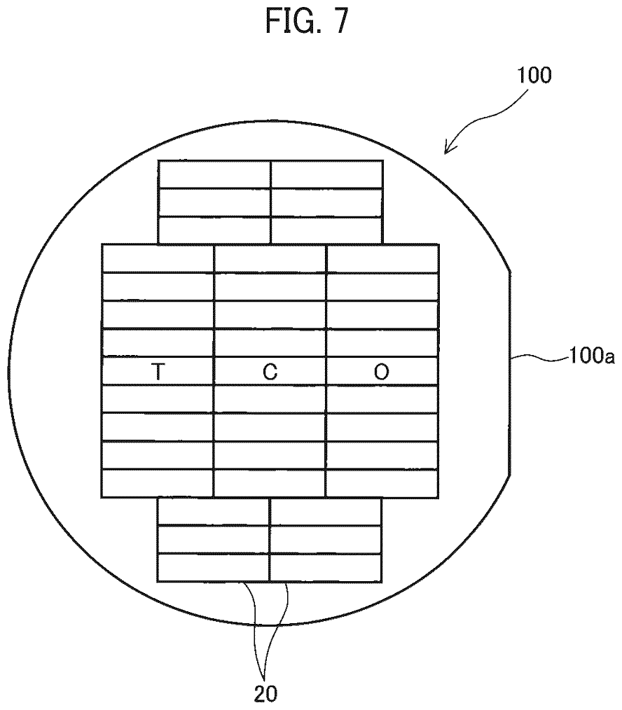

FIG. 7 is a schematic view of a piezoelectric element wafer 100 on which the multiple actuator substrates 20 are formed. On the piezoelectric element wafer 100 illustrated in FIG. 7, the multiple actuator substrates 20 (chips) are formed through the processes described above for manufacturing the liquid discharge head 1. The multiple actuator substrates 20 on the piezoelectric element wafer 100 is separated into pieces by dicing.

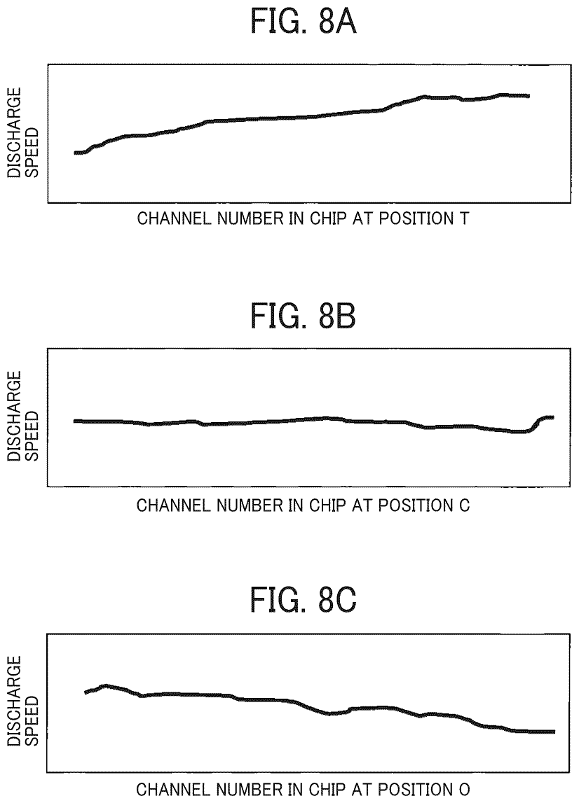

FIG. 8A illustrates an example of average discharge speed distribution of a liquid discharge head using the actuator substrate 20 at a position (position indicated as “T”) on a side opposite a side near an orientation flat 100a of the piezoelectric element wafer 100. FIG. 8B illustrates an example of the average discharge speed distribution of a liquid discharge head using the actuator substrate 20 at a center position (position indicated as “C”) on the piezoelectric element wafer 100. FIG. 8C illustrates an example of the average discharge speed distribution of a liquid discharge head using the actuator substrate 20 at a position (position indicated as “O”) on the side near the orientation flat 100a of the piezoelectric element wafer 100.

The actuator substrates 20 at each position (such as T, C, or O) on the piezoelectric element wafer 100 are assembled into the approximately several hundred liquid discharge heads 1. Discharge speed distributions of the liquid discharge heads 1 are measured by a dedicated measurement device and averaged to acquire the average discharge speed distribution illustrated in each of FIGS. 8A to 8C. Alternatively, a vibration frequency of the actuator substrate 20 may be measured to estimate the discharge speed distribution of the actuator substrate 20 at each position.

As illustrated in FIG. 8A, as for the actuator substrate 20 at the position indicated as “T” illustrated in FIG. 7, a discharge speed gradually increases from one end (left side in FIG. 8A) to the other end in a nozzle arrangement direction. As illustrated in FIG. 8B, as for the actuator substrate 20 at the position indicated as “C” illustrated in FIG. 7, the discharge speed is substantially constant. As illustrated in FIG. 8C, as for the actuator substrate 20 at the position indicated as “O” illustrated in FIG. 7, the discharge speed gradually decreases from one end (left side in FIG. 8C) to the other end in the nozzle arrangement direction.

One reason of these tendencies is the distribution of characteristics formed concentrically (from center to outer periphery) on the piezoelectric element wafer 100 due to, for example, a supply direction of a process gas in chemical vapor deposition (CVD), temperature distribution of the substrate on a sputtering/etching stage, an influence of a coating method such as spin coating. For example, a thickness of the diaphragm 22 gradually increases concentrically.

With such characteristic distribution as described above, in the liquid discharge head using the actuator substrate 20 at the position indicated as “T” or the position indicated as “O” illustrated in FIG. 7, the discharge speed monotonically increases or monotonically decreases from one end (left side in FIG. 8A or 8C) to the other end in the nozzle arrangement direction.

As described with reference to FIG. 3, the actuator component 2 receives thermal stress in the directions indicated by arrows A illustrated in FIG. 3 at the bonding interface due to the difference in the amount of thermal contraction with respect to the frame 3. Due to an influence of this thermal stress, the diaphragm 22 is compressed to be loosened. As a result, since the diaphragm 22 is loosened, a displacement amount of the piezoelectric element 23 becomes larger than when the diaphragm 22 is tensioned. As the displacement amount of each of the piezoelectric elements 23 increases, the discharge speed increases.

In the third example, the void portion 3b in the frame 3 controls a compression amount of the diaphragm 22 at each position in the nozzle arrangement direction to even the discharge speed distribution due to an influence of the actuator substrate 20. A specific description is given below with reference to the drawings.

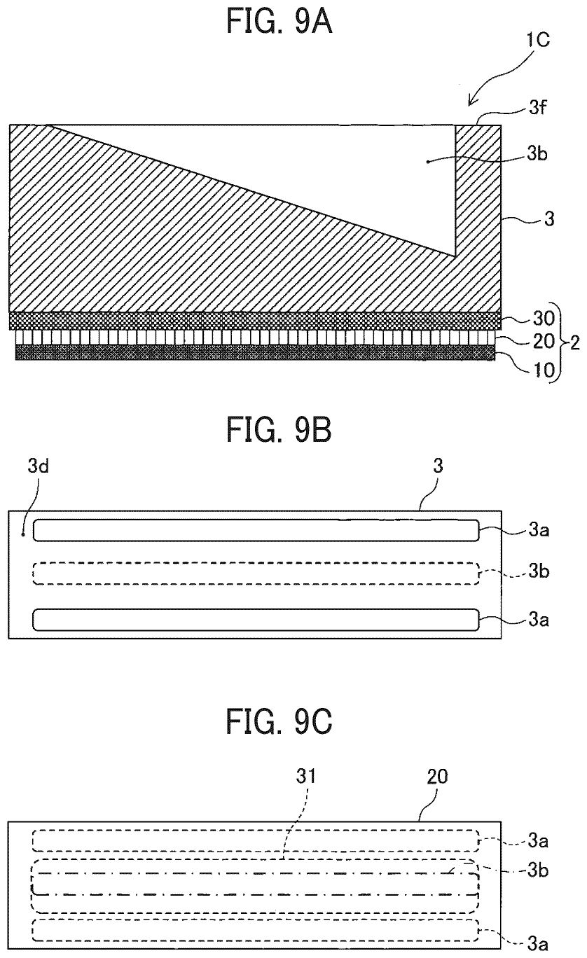

FIGS. 9A to 9C are schematic views of a liquid discharge head 1C according to the third example. FIG. 9A is a schematic cross-sectional view. FIG. 9B is a plan view of a frame 3 of the liquid discharge head 1C, illustrating a formation position of the void portion 3b. FIG. 9C is a plan view of an actuator substrate 20 of the liquid discharge head 1C, illustrating an arrangement region of the piezoelectric element 23.

In the third example, the void portion 3b is a recess in cross section, which is opened only on the face 3f opposite the bonding face 3d of the frame 3. Accordingly, thermal stress due to a difference in the amount of thermal contraction with respect to the frame 3 is likely to be applied to the actuator component 2. The void portion 3b recessed in cross section, which is opened only on the face 3f opposite the bonding face 3d of the frame 3, increases a degree of freedom in layout of the channels in the actuator component 2. Further, bonding area between the actuator component 2 and the frame 3 is not decreased to prevent the deterioration in sealability.

The void portion 3b recessed in cross section does not decrease the rigidity of the frame 3, as compared with a void portion having a through hole (i.e., the through void portion). Accordingly, also in the third example, the frame 3 satisfactorily reinforces the actuator component 2 to prevent the deformation of the actuator component 2 due to, for example, an external force.

As illustrated in FIGS. 9B and 9C, the communicating holes 3a communicating with the common liquid chamber are disposed on both sides in the transverse direction of the frame 3 without overlapping a piezoelectric element arrangement region 31 in which the piezoelectric element 23 is disposed on the actuator substrate 20. The void portion 3b is disposed at the center in the transverse direction described above. As illustrated in FIG. 9C, the void portion 3b overlaps the piezoelectric element arrangement region 31 on the actuator substrate 20. The void portion 3b may protrude from the piezoelectric element arrangement region 31.

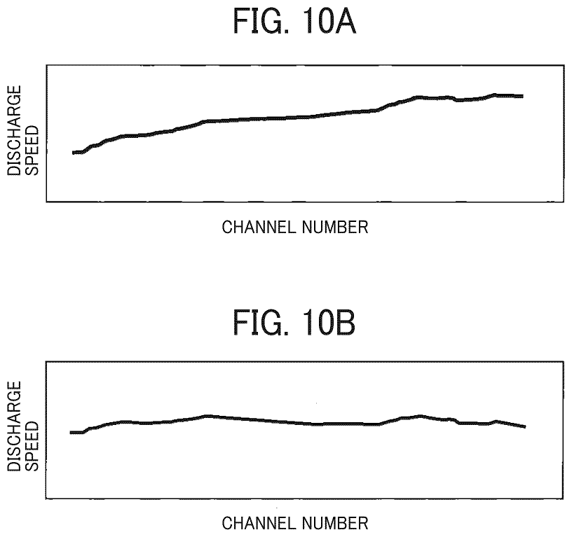

In the third example, the liquid discharge head uses the actuator substrate 20 at the position indicated as T illustrated in FIG. 7. The actuator substrate 20 at the position indicated as T causes a tendency in which the discharge speed gradually and monotonically increases from one end (left side in FIG. 10A) to the other end in the nozzle arrangement direction.

In the third example, the void portion 3b is gradually deepened from one end (left side in FIG. 9A) to the other end in the nozzle arrangement direction based on the tendency of the discharge speed as described above. Specifically, a cross-sectional area of the void portion 3b on a plane orthogonal to the longitudinal direction (may be referred to simply as a cross-sectional area in the following description) monotonically increases. With the void portion 3b having the cross-sectional area described above, a volume of the frame 3 gradually decreases from one end (left side in FIG. 9A) to the other end in the nozzle arrangement direction, and thus the amount of thermal contraction of the frame 3 gradually decreases. As a result, on one end (left side in FIG. 9A) in the nozzle arrangement direction, where the amount of thermal contraction of the frame 3 is large, a loosening amount of the diaphragm 22 increases, the displacement amount of the piezoelectric element 23 increases, and the discharge speed increases. On the other end (right side in FIG. 9A) in the nozzle arrangement direction, where the amount of thermal contraction of the frame 3 is small, the diaphragm 22 is less likely to be loosened, the displacement amount of the piezoelectric element 23 hardly increases, and the discharge speed hardly increases. As illustrated in FIG. 9A, as the cross-sectional area of the void portion 3b monotonically increases, the discharge speed due to an influence of the void portion 3b (influence of thermal contraction of the frame 3) monotonically decreases.

When the actuator substrate 20 at the position indicated as T illustrated in FIG. 7 is used, the discharge speed gradually increases from one end (left side in FIG. 10A) to the other end in the nozzle arrangement direction due to the influence of the actuator substrate 20 as illustrated in FIG. 10A. The frame 3 having the void portion 3b having the cross-sectional area increasing from the one end to the other end as illustrated in FIG. 9A (influence of thermal contraction of the frame 3) cancels the influence of the position of the actuator substrate 20 to substantially even the discharge speed distribution as illustrated in FIG. 10B.

As illustrated in FIG. 9C, the communicating holes 3a are formed without overlapping the piezoelectric element arrangement region 31 as viewed in the liquid discharge direction. Thus, an influence of a structure of the communicating holes 3a on thermal stress applied to the bonding interface in the piezoelectric element arrangement region 31 can be prevented. Accordingly, it is not necessary to take the structure of the communicating holes 3a into consideration to determine the shape (cross-sectional area) of the void portion 3b. Thus, the shape (cross-sectional area) of the void portion 3b can easily be set to even the discharge speed distribution.

As illustrated in FIG. 9C, the void portion 3b overlaps the piezoelectric element arrangement region 31 as viewed in the liquid discharge direction. Thus, the structure of the void portion 3b largely affects the thermal stress applied to the bonding interface in the piezoelectric element arrangement region 31. The amount of thermal contraction of the actuator component 2 at location can be satisfactorily controlled by the shape (cross-sectional area) of the void portion 3b. Accordingly, variations in the discharge speed due to the characteristics of the actuator substrate 20 can be satisfactorily reduced by the shape (cross-sectional area) of the void portion 3b.

In the above description, the actuator substrate 20 at the position indicated as T illustrated in FIG. 7 is used. When the actuator substrate 20 at the position indicated as O illustrated in FIG. 7 is used, the void portion 3b gradually becomes shallower from one end (left side in FIG. 9A) to the other end in the nozzle arrangement direction. Thus, the frame 3 has a void portion having a cross-sectional area that monotonously decreases. The frame 3 having the void portion having the cross-sectional area that monotonously decreases is bonded to the actuator substrate 20. Accordingly, the void portion 3b reduces variations in the discharge speed.

When the actuator substrate 20 at the position indicated as C illustrated in FIG. 7 is used, the frame 3 having a void portion with a constant cross-sectional area in the nozzle arrangement direction is bonded to the actuator component 2. Thus, variations in the discharge speed can be reduced.

As described above, in the third example, the thermal stress applied to the actuator component 2 is reduced while the rigidity of the frame 3 is maintained to reduce variations in the discharge speed.

In the third example, for example, three frames 3 are prepared, which are: a frame having the void portion 3b having a cross-sectional area monotonously increasing from one end (left side in the drawings) to the other end in the nozzle arrangement direction for the actuator substrate 20 at the position indicated as “T,” a frame having a cross-sectional area monotonously decreasing from one end (left side in the drawings) to the other end in the nozzle arrangement direction for the actuator substrate 20 at the position indicated as “O,” and a frame having a constant cross-sectional area in the nozzle arrangement direction for the actuator substrate 20 at the position indicated as “C.” Based on a position (O, C, or T) of each of the actuator substrates 20 on the piezoelectric element wafer 100, the corresponding one of the three frames 3 is selected and bonded to the actuator substrate 20. Such a combination of the frame 3 and the actuator substrate 20 reduces variations in the discharge speed, which is caused by a difference in the characteristic distribution depending on the position of each of the actuator substrates 20 on the piezoelectric element wafer 100.

The shape of the void portion 3b illustrated in FIGS. 9A to 9C is one example. In accordance with the average discharge speed distribution due to the characteristics of the actuator substrate 20 at each position (O, C, or T) on the piezoelectric element wafer 100, a void portion may be formed by appropriately combining a region where the cross-sectional area monotonously increases, a region where the cross-sectional area is constant, and a region where the cross-sectional area monotonously decreases.

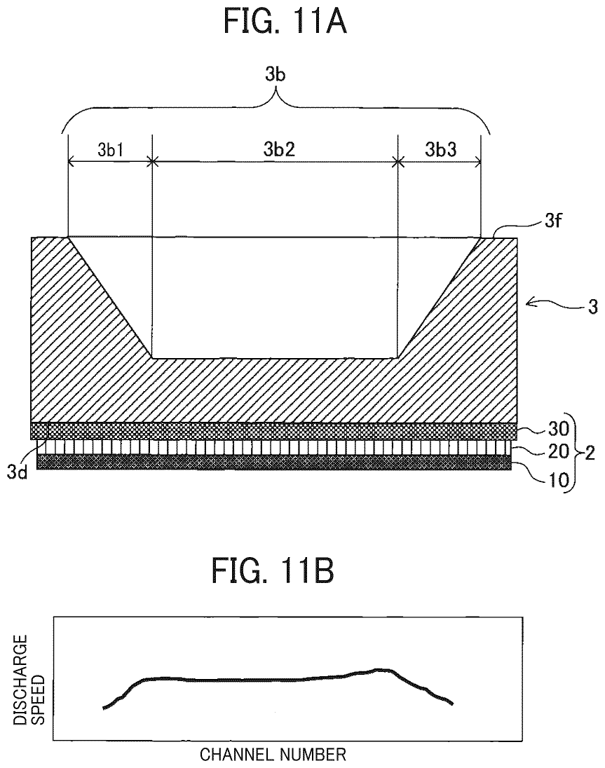

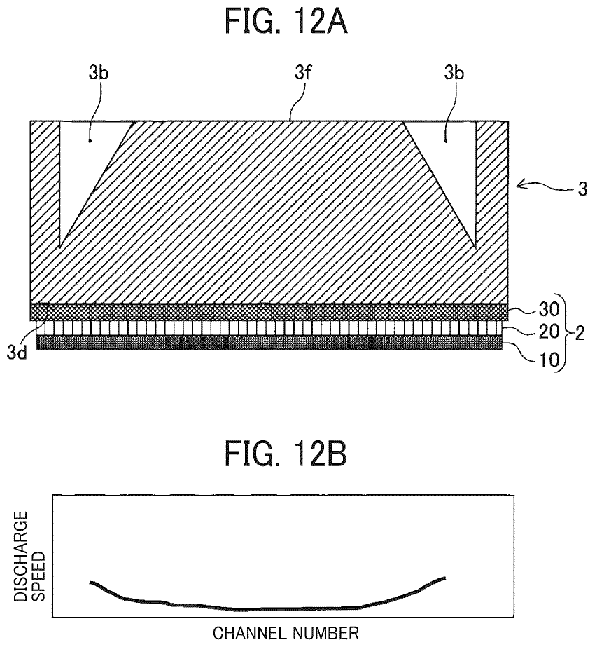

For example, when the actuator substrate 20 at the position indicated as “C” on the piezoelectric element wafer 100 is used, the discharge speed distribution illustrated in FIG. 11B or 12B may appear depending on a manufacturing method of the piezoelectric element wafer 100.

When using the actuator substrate 20 having the discharge speed distribution in which the discharge speed on both sides in the nozzle arrangement direction gradually decreases toward ends and the discharge speed in the center portion is substantially constant as illustrated in FIG. 11B, a frame 3 having a void portion 3b with a cross-sectional area as illustrated in FIG. 11A is used. The void portion 3b in the frame 3 illustrated in FIG. 11A includes a region 3b1, in which the cross-sectional area monotonously increases toward the center, on one end (left side in FIG. 11A) in the nozzle arrangement direction, a region 3b2 having the constant cross-sectional area in the center portion, and a region 3b3, in which the cross-sectional area monotonously decreases toward the other end, on the other end (right side in FIG. 11A) in the nozzle arrangement direction. In other words, it can be said that multiple void portions (e.g., the regions 3b1, 3b2, and 3b3) are continuously connected to each other in the longitudinal direction to form the void portion 3b.

When using the actuator substrate 20 having the discharge speed distribution in which the discharge speed on both sides in the nozzle arrangement direction gradually increases toward ends and the discharge speed in the center portion is substantially constant as illustrated in FIG. 12B, a frame 3 having a void portion 3b as illustrated in FIG. 12A is used. For example, the void portions 3b are disposed on one end (left side in FIG. 12A) and the other end (right side in FIG. 12A) in the nozzle arrangement direction. The void portion 3b on the one end (left side in FIG. 12A) in the nozzle arrangement direction has a cross-sectional area monotonously decreasing toward the center and the void portion 3b on the other end (right side in FIG. 12A) in the nozzle arrangement direction has a cross-sectional area monotonously increasing toward the other end.

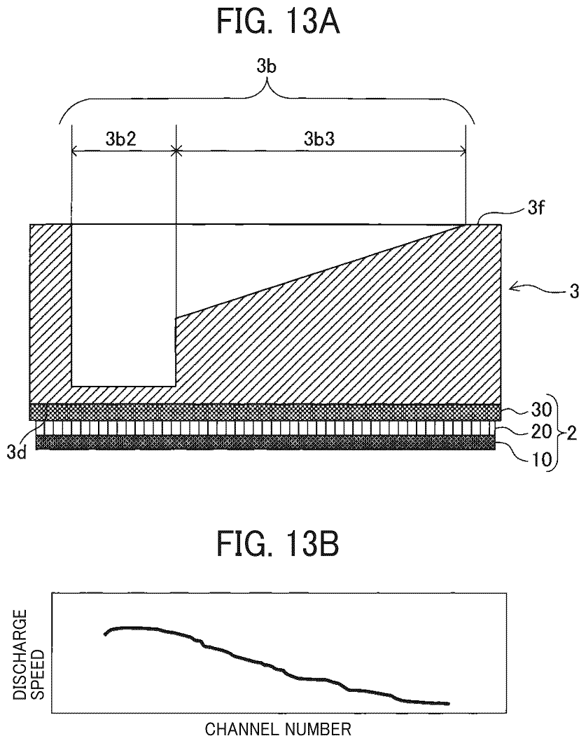

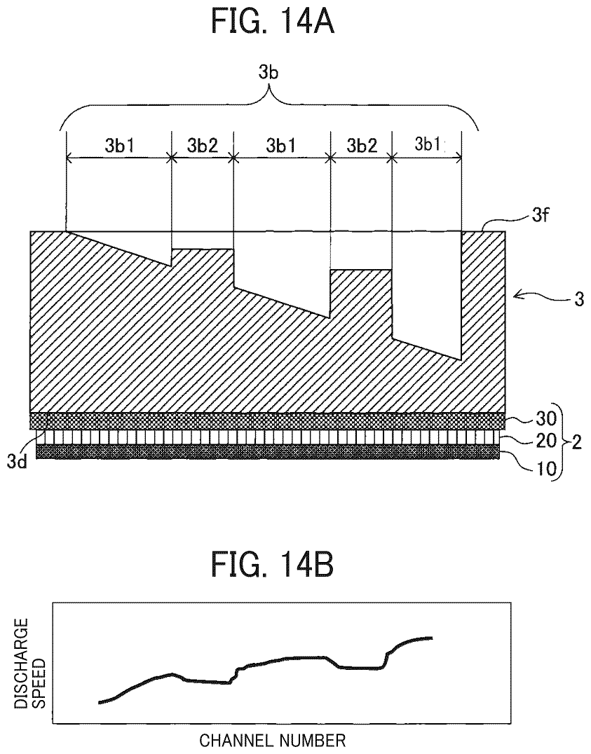

When the actuator substrate 20 at the position indicated as “T” or “O” on the piezoelectric element wafer 100 is used, the discharge speed distribution illustrated in FIG. 13B or 14B may appear depending on the manufacturing method of the piezoelectric element wafer 100.

When using the actuator substrate 20 having the discharge speed distribution in which the discharge speed on one end (left side in FIG. 13B) in the nozzle arrangement direction illustrated in FIG. 13B is substantially constant and the discharge speed gradually decreases from the center toward the other end (right side in FIG. 13B), a frame 3 having a void portion 3b as illustrated in FIG. 13A is used. The frame 3 has the void portion 3b including the region 3b2 having the constant cross-sectional area on one end (left side in FIG. 13A) in the nozzle arrangement direction and the region 3b3 having the cross-sectional area monotonously decreasing from the center toward the other end.

When using the actuator substrate 20 having the discharge speed distribution including a region in which the discharge speed gradually increases from one end (left side in FIG. 14B) toward the other end in the nozzle arrangement direction and a region in which the discharge speed is substantially constant, which are alternately repeated as illustrated in FIG. 14B, a frame 3 having a void portion 3b as illustrated in FIG. 14A is used. The frame has the void portion 3b including the region 3b1 having the cross-sectional area monotonously increasing toward the other end in the nozzle arrangement direction and the region 3b2 having the constant cross-sectional area, which are alternately repeated.

Those shapes of the frame 3 described above are mere examples. The void portion 3b in the frame 3 may be appropriately determined based on the average discharge speed distribution of the actuator substrate 20 at each position on the piezoelectric element wafer 100, which has been acquired in advance through experiments.

The void portion 3b in the frame 3 according to the third example may be a closed void portion having no opening or a void portion having a recess in cross section, which is opened only on the bonding face 3d. Even with such a void portion, a decrease in the rigidity of the frame 3 can be prevented, as compared with a configuration having a through void portion. Accordingly, also in the third example, the frame 3 satisfactorily reinforces the actuator component 2 to prevent the deformation of the actuator component 2 due to, for example, an external force.

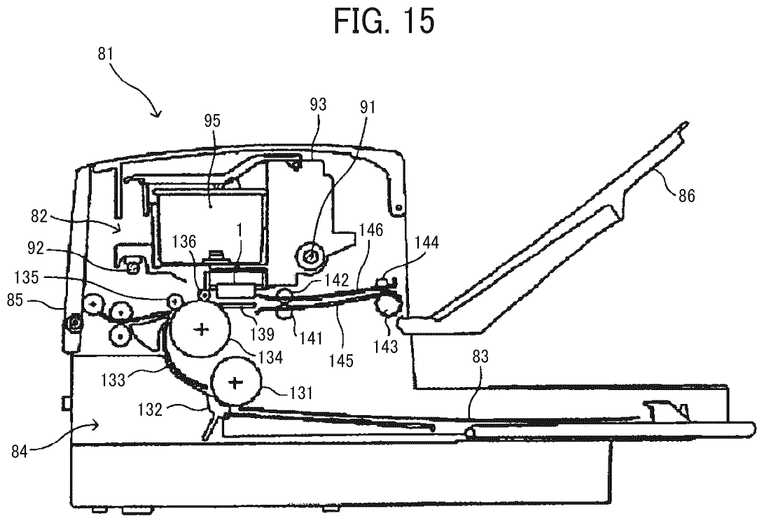

A description is given below of an inkjet recording apparatus as a liquid discharge apparatus including the liquid discharge head in the first to third examples described above as an inkjet head. FIG. 15 is a side view of the inkjet recording apparatus, illustrating a mechanical section thereof.

The inkjet recording apparatus houses a printing mechanism 82 including a carriage 93, liquid discharge heads 1, and ink cartridges 95 in an apparatus body 81. The carriage 93 is movable in a main scanning direction. The liquid discharge heads 1 and the ink cartridges 95 are mounted on the carriage 93. The ink cartridge 95 supplies ink as a liquid to the liquid discharge head 1. A sheet feeding cassette (or sheet feeding tray) 84 is detachably attached to the lower portion of the apparatus body 81 from the front side. A plurality of sheets 83 is loaded on the sheet feeding cassette 84. A bypass tray 85 can be inclined to open to manually feed the sheets 83. When the sheet 83 is fed from the sheet feeding cassette 84 or the bypass tray 85, the printing mechanism 82 records a desired image on the sheet 83. Then, the sheet 83 is ejected onto a sheet ejection tray 86.

In the printing mechanism 82, a main guide rod 91 and a sub-guide rod 92, serving as guides laterally bridged between a left side plate and a right side plate, support the carriage 93 slidably in the main scanning direction. The carriage 93 includes the liquid discharge heads 1 to discharge liquids (inks) of respective colors of yellow (Y), cyan (C), magenta (M), and black (K). The liquid discharge heads 1 are mounted on the carriage 93 and each have a nozzle array including multiple nozzle holes arranged in a direction intersecting the main scanning direction. The liquid discharge heads 1 discharge the respective color inks downward from the multiple nozzle holes. The ink cartridges 95 are replaceably attached to the carriage 93 to supply the respective color inks to the liquid discharge heads 1.

Each of the ink cartridges 95 has an atmosphere communication port, a supply port, and a porous body. The porous body is disposed inside each ink cartridge 95 to be filled with ink. Ink to be supplied to the liquid discharge heads 1 is kept at a slight negative pressure by capillary force of the porous body. The atmosphere communication port is disposed at an upper portion of each ink cartridge 95 to communicate with the atmosphere. The supply port is disposed at a lower portion of each ink cartridge 95 to supply ink to the corresponding liquid discharge head 1. As described above, the liquid discharge heads 1 are provided individually for the respective color inks, but a single recording head may discharge the respective color inks.

The downstream side of the carriage 93 in a sheet conveyance direction is slidably fitted onto the main guide rod 91, and the upstream side of the carriage 93 in the sheet conveyance direction is slidably mounted onto the sub-guide rod 92. In order to move the carriage 93 in the main scanning direction, a timing belt is stretched between a drive pulley rotationally driven by a main scanning motor and a driven pulley. The carriage 93 is fixed to the timing belt. The carriage 93 is reciprocally moved by forward and reverse rotations of the main scanning motor.

In order to convey a sheet 83 set in the sheet feeding cassette 84 to the lower side of the liquid discharge heads 1, the inkjet recording apparatus includes a sheet feeding roller 131 and a friction pad 132 to separate and feed the sheet 83 from the sheet feeding cassette 84, a guide member 133 to guide the sheet 83, a conveyance roller 134 to turn and convey the fed sheet 83, a conveyance roller 135 pressed against the circumferential surface of the conveyance roller 134, and a leading end roller 136 to define the feed angle of the sheet 83 from the conveyance roller 134. The conveyance roller 134 as a conveyor is rotationally driven by a sub-scanning motor via a gear train.

The inkjet recording apparatus further includes a print receiver 139 disposed below the liquid discharge heads 1. The print receiver 139 is a sheet guide to guide the sheet 83, which is fed from the conveyance roller 134, in a range corresponding to a range of movement of the carriage 93 in the main scanning direction. A conveyance roller 141 and a spur roller 142 are disposed on the downstream side of the print receiver 139 in the sheet conveyance direction. The conveyance roller 141 is driven to rotate so as to feed the sheet 83 in a sheet ejection direction. The inkjet recording apparatus further includes a sheet ejection roller 143 and a spur roller 144 to feed the sheet 83 to the sheet ejection tray 86 and guides 145 and 146 that define a sheet ejection passage.

At the time of recording, the inkjet recording apparatus drives the liquid discharge heads 1 in response to an image signal while moving the carriage 93 to discharge ink onto the sheet 83, which is stopped below the liquid discharge heads 1, to record one line of a desired image on the sheet 83. After that, the sheet 83 is conveyed by a predetermined amount, and then the next line of the desired image is recorded on the sheet 83. In response to a recording end signal or a signal indicating that the trailing end of the sheet 83 has reached a recording area, the inkjet recording apparatus ends the recording operation and ejects the sheet 83.

The inkjet recording apparatus further includes a recovery device to recover the liquid discharge heads 1 from a discharge failure. The recovery device is disposed at a position outside the recording area at the right end in a movement direction of the carriage 93. The recovery device includes a cap unit, a suction unit, and a cleaning unit. On standby for printing, the carriage 93 is placed on the side on which the recovery device is disposed, and the liquid discharge heads 1 are capped with the cap unit. Accordingly, the nozzle holes are maintained in a wet state, thus preventing discharge failure due to ink drying. In addition, during recording, the inkjet recording apparatus discharges ink not relating to the recording to maintain the viscosity of ink in all of the nozzle holes constant, thus maintaining a stable discharging performance.

For example, when the discharge failure occurs, the nozzle holes of the liquid discharge heads 1 are sealed with the cap unit, the suction unit sucks bubbles along with ink from the nozzle holes through a tube, and the cleaning unit removes ink and dust adhered to the nozzle face to recover the liquid discharge head 1 from the discharge failure. The sucked ink is drained to a waste ink container disposed at a lower portion of the apparatus body 81, and is absorbed into and retained in an ink absorber in the waste ink container.

The inkjet recording apparatus mounts the liquid discharge head 1 in the first to third examples described above. Thus, stable ink discharge characteristics are obtained to enhance image quality.

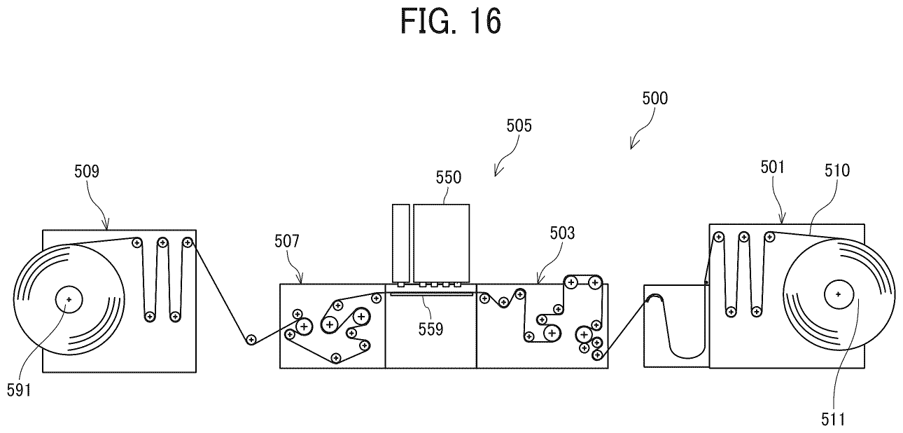

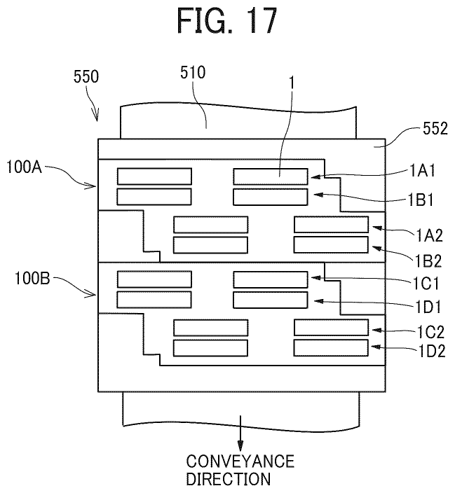

FIG. 16 is a schematic view of a printer 500, which is another example of the inkjet recording apparatus. FIG. 17 is a plan view of a head unit of the printer 500.

The printer 500 illustrated in FIG. 16 includes a feeder 501 as a conveyor and a guide conveyor 503. The feeder 501 feeds a continuous medium 510. The guide conveyor 503 guides and conveys the continuous medium 510 conveyed from the feeder 501 to a printing device 505. The printer 500 also includes the printing device 505, a dryer 507, and a carrier 509. The printing device 505 discharges liquid onto the continuous medium 510 to form an image. The dryer 507 dries the continuous medium 510. The carrier 509 ejects the continuous medium 510.

The continuous medium 510 (i.e., a medium) is fed from a winding roller 511 of the feeder 501, guided and conveyed with rollers of the feeder 501, the guide conveyor 503, the dryer 507, and the carrier 509, and wound around a take-up roller 591 of the carrier 509. In the printing device 505, the continuous medium 510 is conveyed on a conveyance guide 559 so as to face a head unit 550. The head unit 550 discharges a liquid onto the continuous medium 510 to form an image.

In the printer 500, as illustrated in FIG. 16, the head unit 550 includes the two head modules 100A and 100B on a common base 552. The head module 100A includes head arrays 1A1, 1B1, 1A2, and 1B2. Each of the head arrays 1A1, 1B1, 1A2, and 1B2 includes multiple liquid discharge heads 1 arranged in a head array direction perpendicular to a conveyance direction of the continuous medium 510. The head module 100B includes head arrays 1C1, 1D1, 1C2, and 1D2. Each of the head arrays 1C1, 1D1, 1C2, and 1D2 includes multiple liquid discharge heads 1 arranged in the head array direction. The head arrays 1A1 and 1A2 of the head module 100A discharge a liquid of the same color. Similarly, the head arrays 1B1 and 1B2 of the head module 100A are grouped as one set and discharge a liquid of the same desired color. The head arrays 1C1 and 1C2 of the head module 100B are grouped as one set and discharge a liquid of the same desired color. The head arrays 1D1 and 1D2 of the head module 100B are grouped as one set and discharge a liquid of the same desired color.

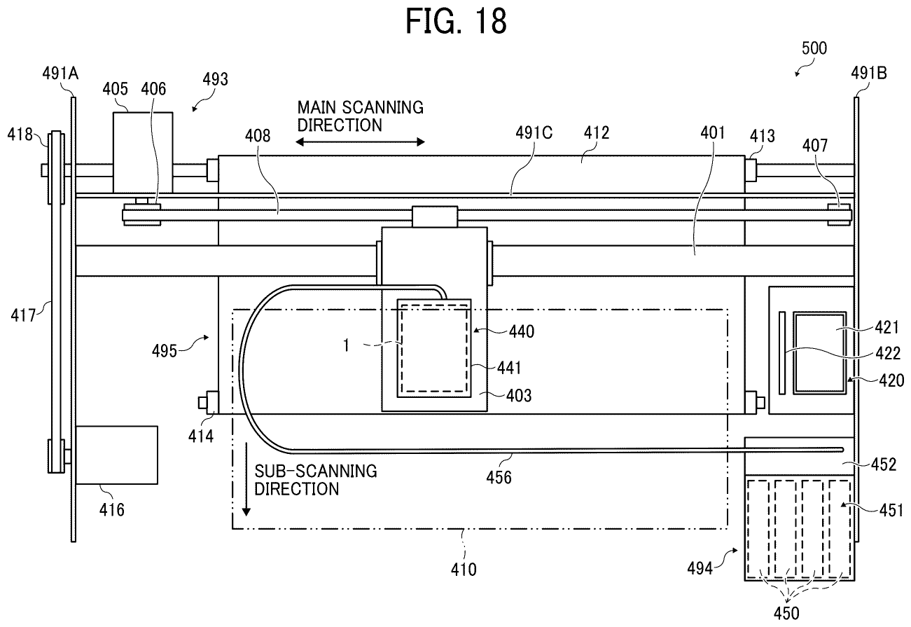

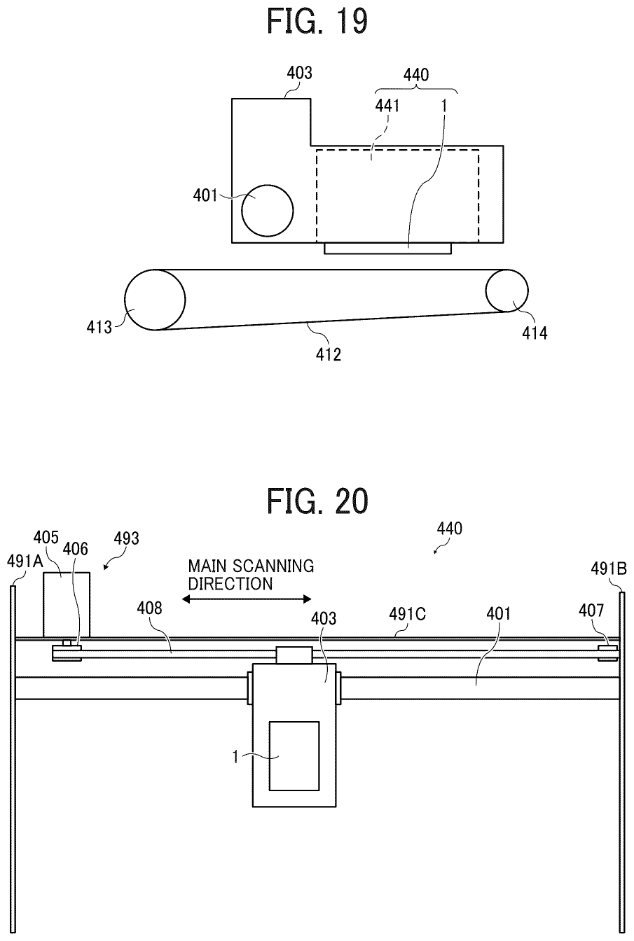

Another example (modification) of the inkjet recording apparatus as a liquid discharge apparatus is described below with reference to FIGS. 18 and 19. FIG. 18 is a plan view of a part of an inkjet recording apparatus according to the present modification. FIG. 19 is a side view of the part of the inkjet recording apparatus according to the present modification.

Another printer 500 (i.e., the inkjet recording apparatus according to the present modification) is a serial type apparatus. A main-scanning moving mechanism 493 moves a carriage 403 reciprocally in a main scanning direction. The main-scanning moving mechanism 493 includes, for example, a guide 401, a main scanning motor 405, and a timing belt 408. The guide 401 is bridged between left and right side plates 491A and 491B to movably hold the carriage 403. The main scanning motor 405 reciprocates the carriage 403 in the main scanning direction via the timing belt 408 looped around a drive pulley 406 and a driven pulley 407.

The carriage 403 mounts a liquid discharge unit 440 in which the liquid discharge head 1 described above and a head tank 441 are integrated into a single unit. The liquid discharge head 1 of the liquid discharge unit 440 discharges color liquids of, for example, yellow (Y), cyan (C), magenta (M), and black (K). The liquid discharge head 1 has a nozzle array including the multiple nozzles arranged in a sub-scanning direction perpendicular to the main scanning direction. The liquid discharge head 1 discharges the color liquids downward from the multiple nozzles.

A supply mechanism 494 disposed outside the liquid discharge head 1 supplies liquid stored in liquid cartridges 450 to the head tank 441 to supply the liquid to the liquid discharge head 1. The supply mechanism 494 includes a cartridge holder 451 which is a loading device to mount the liquid cartridges 450, a tube 456, and a liquid feed unit 452 including a liquid feed pump. The liquid cartridge 450 is detachably mounted on the cartridge holder 451. The liquid feed unit 452 feeds the liquid from the liquid cartridge 450 to the head tank 441 via the tube 456.

The printer 500 (the inkjet recording apparatus) further includes a conveyance mechanism 495 to convey a sheet 410 (i.e., a medium). The conveyance mechanism 495 includes a conveyance belt 412 (i.e., a conveyor) and a sub-scanning motor 416 to drive the conveyance belt 412. The conveyance belt 412 attracts the sheet 410 to convey the sheet 410 to a position facing the liquid discharge head 1. The conveyance belt 412 is an endless belt stretched between a conveyance roller 413 and a tension roller 414. The sheet 410 can be attracted to the conveyance belt 412 by, for example, electrostatic attraction or air suction. The conveyance belt 412 circumferentially moves in the sub-scanning direction as the conveyance roller 413 is rotationally driven by the sub-scanning motor 416 via a timing belt 417 and a timing pulley 418.

On one end of the range of movement of the carriage 403 in the main scanning direction, a maintenance mechanism 420 that maintains and recovers the liquid discharge head 1 is disposed lateral to the conveyance belt 412. The maintenance mechanism 420 includes, for example, a cap 421 to cap the nozzle face (i.e., the surface on which the nozzles are formed) of the liquid discharge head 1 and a wiper 422 to wipe the nozzle face.

The main-scanning moving mechanism 493, the supply mechanism 494, the maintenance mechanism 420, and the conveyance mechanism 495 are mounted onto a housing including the side plates 491A and 491B and a back plate 491C. In the printer 500 having the above-described configuration, the sheet 410 is fed and attracted onto the conveyance belt 412 and conveyed in the sub-scanning direction as the conveyance belt 412 circumferentially moves. The liquid discharge head 1 is driven in response to an image signal while the carriage 403 is moved in the main scanning direction to discharge a liquid onto the sheet 410 not in motion to form an image.

As described above, the inkjet recording apparatus according to the present modification includes the liquid discharge head 1 described in the first to third examples, thus allowing stable formation of high-quality images.

Another liquid discharge unit 440 is described below with reference to FIG. 20. FIG. 20 is a plan view of a part of the liquid discharge unit 440. The liquid discharge unit 440 includes the housing, the main-scanning moving mechanism 493, the carriage 403, and the liquid discharge head 1 among the components of the inkjet recording apparatus described above. The side plates 491A and 491B, and the back plate 491C construct the housing. The liquid discharge unit 440 may further include at least one of the maintenance mechanism 420 or the supply mechanism 494, which may be attached to the side plate 491B.

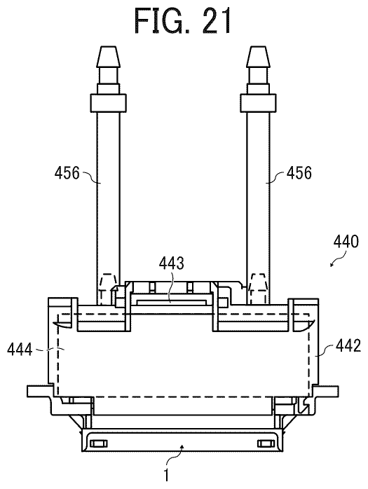

Yet another liquid discharge unit 440 is described below with reference to FIG. 21. FIG. 21 is a front view of the liquid discharge unit 440. The liquid discharge unit 440 includes the liquid discharge head 1 to which a channel component 444 is attached, and a tube 456 connected to the channel component 444. The channel component 444 is disposed inside a cover 442. Alternatively, the liquid discharge unit 440 may include the head tank 441 instead of the channel component 444. A connector 443 for electrically connecting to the liquid discharge head 1 is disposed on an upper portion of the channel component 444.

In the present disclosure, the liquid to be discharged is not limited to a particular liquid as long as the liquid has a viscosity or surface tension to be discharged from a head (liquid discharge head). However, preferably, the viscosity of the liquid is not greater than 30 millipascal-second (mPa·s) under ordinary temperature and ordinary pressure or by heating or cooling. More specifically, examples of the liquid to be discharged include a solution, a suspension, an emulsion, or molten metal such as solder including, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; and an edible material, such as a natural colorant. Such a solution, a suspension, an emulsion, or molten metal can be used for, e.g., inkjet ink; surface treatment liquid; a liquid for forming an electronic element component, a light-emitting element component, an electronic circuit resist pattern, or a solder bump; or a material solution for three-dimensional fabrication.

The “liquid discharge unit” is an assembly of parts relating to liquid discharge. The term “liquid discharge unit” represents a structure including the liquid discharge head and a functional component(s) or mechanism(s) combined with the liquid discharge head as a single unit. For example, the “liquid discharge unit” includes a combination of the liquid discharge head with at least one of a head tank, a carriage, a supply mechanism, a maintenance mechanism, or a main-scanning moving mechanism.

The above integration may be achieved by, for example, a combination in which the liquid discharge head and a functional component(s) or mechanism(s) are fixed to each other through, e.g., fastening, bonding, or engaging, and a combination in which one of the liquid discharge head and the functional component(s) or mechanism(s) is movably held to the other. The liquid discharge head and the functional component(s) or mechanism(s) may be detachably attached to each other.

For example, the liquid discharge head and the head tank are integrated to form the liquid discharge unit as a single unit. Alternatively, the liquid discharge head and the head tank coupled (connected) to each other via, for example, a tube may form the liquid discharge unit as a single unit. A unit including a filter may further be added to a portion between the head tank and the liquid discharge head of the liquid discharge unit.

In another example, the liquid discharge unit may be an integrated unit in which a liquid discharge head is integrated with a carriage.

As yet another example, the liquid discharge unit is a unit in which the liquid discharge head and the main-scanning moving mechanism are combined into a single unit. The liquid discharge head is movably held by a guide that is a part of the main-scanning moving mechanism. The liquid discharge unit may include the liquid discharge head, the carriage, and the main-scanning moving mechanism that are integrated as a single unit.

In another example, the cap that forms a part of the maintenance mechanism is fixed to the carriage mounting the liquid discharge head so that the liquid discharge head, the carriage, and the maintenance mechanism are integrated as a single unit to form the liquid discharge unit.

Further, in still another example, the liquid discharge unit includes tubes connected to the liquid discharge head mounting the head tank or the channel component so that the liquid discharge head and the supply mechanism are integrated as a single unit. Through the tube, the liquid in a liquid storage source is supplied to the liquid discharge head.

The main-scanning moving mechanism may be a guide only. The supply mechanism may be a tube(s) only or a loading device only.

The term “liquid discharge apparatus” used herein also represents an apparatus including the liquid discharge head or the liquid discharge unit to drive the liquid discharge head to discharge liquid. The liquid discharge apparatus may be, for example, any apparatus that can discharge liquid to a medium onto which liquid can adhere or any apparatus to discharge liquid toward gas or into a different liquid.

The “liquid discharge apparatus” may further include devices relating to feeding, conveying, and ejecting of the material onto which liquid can adhere and also include a pretreatment device and an aftertreatment device.

The “liquid discharge apparatus” may be, for example, an image forming apparatus to form an image on a sheet by discharging ink, or a three-dimensional fabrication apparatus to discharge fabrication liquid to a powder layer in which powder material is formed in layers, so as to form a three-dimensional object.

The “liquid discharge apparatus” is not limited to an apparatus that discharges liquid to visualize meaningful images such as letters or figures. For example, the liquid discharge apparatus may be an apparatus that forms patterns having no meaning or an apparatus that fabricates three-dimensional images.

The above-described term “medium onto which liquid can adhere” represents a medium on which liquid is at least temporarily adhered, a medium on which liquid is adhered and fixed, or a medium into which liquid adheres and permeates. Specific examples of the “medium onto which liquid can adhere” include, but are not limited to, a recording medium such as paper, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of materials for the “medium onto which liquid can adhere” include any materials to which liquid can adhere even temporarily, such as paper, thread, fiber, fabric, leather, metal, plastic, glass, wood, and ceramic.

The “liquid discharge apparatus” may be an apparatus to move the liquid discharge head and the medium onto which liquid can adhere relative to each other. However, the liquid discharge apparatus is not limited to such an apparatus. For example, the liquid discharge apparatus may be a serial head apparatus that moves the liquid discharge head or a line head apparatus that does not move the liquid discharge head.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particles of the raw material.

The terms “image formation,” “recording,” “printing,” “image printing,” and “fabricating” used herein may be used synonymously with each other.

The above-described embodiments are illustrative and do not limit the embodiments of the present disclosure. Thus, numerous additional modifications and variations are possible in light of the above teachings. For example, elements and/or features of different illustrative embodiments may be combined with each other and/or substituted for each other within the scope of the present disclosure.

The embodiments described above are merely examples, and the aspects of the present disclosure exert the respective effects as follows.

### Aspect 1

A liquid discharge head such as the liquid discharge head 1 includes a substrate component and a reinforcing member. The substrate component such as the actuator component 2 includes the diaphragm 22 and the piezoelectric elements 23. The diaphragm 22 is laminated on a substrate such as the pressure chamber substrate 21 formed with liquid chambers such as the pressure chambers 21b communicating with nozzles such as the nozzle holes 10a. The diaphragm 22 forms part of wall surfaces of the liquid chambers. The piezoelectric elements 23 are laminated on a surface of the diaphragm 22 on a side opposite a side forming the wall surfaces of the liquid chambers. The reinforcing member such as the frame 3 has communicating portions such as the communicating holes 3a communicating with the liquid chambers. The reinforcing member is bonded to the substrate component with the adhesive 50. The reinforcing member has the multiple void portions 3b in addition to the communicating portions.

In other words, a liquid discharge head includes an actuator component and a frame. The actuator component includes a nozzle substrate and an actuator substrate. The nozzle substrate has nozzles arrayed in a longitudinal direction of the nozzle substrate. The actuator substrate includes a chamber substrate, a diaphragm, and a piezoelectric element. The chamber substrate is disposed over the nozzle substrate. The chamber substrate has pressure chambers respectively communicating with the nozzles. The diaphragm is disposed over the chamber substrate. The diaphragm has a first face serving as a part of a wall face of the pressure chambers and a second face opposite the first face. The piezoelectric element is disposed over the second face of the diaphragm, to discharge a liquid in the pressure chambers from the nozzles in a discharge direction orthogonal to the longitudinal direction. The frame has a bonding face bonded to the actuator component with an adhesive, communicating portions communicating with the pressure chambers, and multiple void portions.

Typically, silicon is used to form the substrate component such as the actuator component 2. A resin material having a larger linear expansion coefficient than that of the substrate component is used to form the reinforcing member such as the frame 3. When the linear expansion coefficient of the reinforcing member is larger than the linear expansion coefficient of the substrate component, as described above, amounts of thermal expansion and thermal contraction of the reinforcing member become larger than those of the substrate component. A thermosetting adhesive is typically used for bonding the substrate component and the reinforcing member. An amount of thermal contraction of the reinforcing member becomes greater than that of the substrate component when the substrate component and the reinforcing member return to the room temperature after the substrate component and the reinforcing member are heated to cure the adhesive, and the substrate component and the reinforcing member are bonded to each other. As a result, stress (may be referred to as thermal stress) that causes the substrate component to contract is generated via the bonding portion between the substrate component and the reinforcing member. The thermal stress may cause the rigidity of the diaphragm 22 and the piezoelectric elements 23 of the substrate component to change, resulting in an influence on the discharging performance for the liquid from the nozzles such as the nozzle holes 10a.

In a comparative example, a reinforcing member such as a reinforcing frame has a frame shape, and the reinforcing member is provided with a void portion, which is a large rectangular through hole, to reduce the volume of the reinforcing member so as to reduce the amount of thermal contraction of the reinforcing member. Such a configuration reduces thermal stress applied to the substrate component. However, the rigidity of the reinforcing member may be lowered, and it becomes difficult to firmly reinforce the substrate component. As a result, the deformation due to an external force may not be prevented.

On the other hand, in Aspect 1, the multiple void portions are disposed in the reinforcing member. Due to such a configuration, the reinforcing member with the partitions 3e that partition the void portions is reinforced, and thus the rigidity of the reinforcing member is enhanced. Accordingly, the substrate component is satisfactorily reinforced by the reinforcing member, and the deformation of the substrate component due to an external force is prevented, as compared with a frame-shaped reinforcing member having a void portion which is a large through hole disposed at the center.

The multiple void portions 3b reduce the volume of the reinforcing member. Accordingly, the amount of thermal contraction of the reinforcing member is reduced when the reinforcing member returns to the room temperature after the reinforcing member and the substrate component are bonded to each other. As a result, the thermal stress applied to the substrate component is reduced, and a change in the rigidity of the diaphragm 22 and the piezoelectric elements 23 is reduced, to prevent the deterioration in the liquid discharging performance.

### Aspect 2

In the liquid discharge head of Aspect 1, the multiple void portions 3b are formed in the longitudinal direction of the liquid discharge head.

In other words, the multiple void portions are arranged in the longitudinal direction.

With this configuration, as described in the first example, the rigidity of the frame 3 is maintained, and the volume of the frame 3 is reduced, as compared with the multiple void portions formed in the transverse direction of the liquid discharge head.

### Aspect 3

In the liquid discharge head of Aspect 1 or 2, the multiple void portions 3b each has an opening on the bonding face 3d of the reinforcing member such as the frame 3. The substrate component such as the actuator component 2 is bonded to the bonding face 3d of the reinforcing member.

In other words, the multiple void portions have openings on the bonding face of the frame.

With this configuration, as described in the first example, thermal contraction on the bonding face of the reinforcing member such as the frame 3 is reduced. Thus, the thermal stress applied to the substrate component such as the actuator component 2 via the bonding portion is reduced.

### Aspect 4

In the liquid discharge head of Aspect 3, among the multiple void portions, at least one void portion is the through void portion 3b-1 penetrating through the reinforcing member such as the frame 3, and other void portions are the void portions 3b-2 each having a recess in cross section, which is opened only on the bonding face 3d.

In other words, a part of the multiple void portions has a through void portion penetrating through the frame, and other part of the multiple void portions has recesses recessed from the bonding face of the frame.

With this configuration, as described in the second example, thermal contraction on the bonding face of the reinforcing member such as the frame 3 is reduced, and a decrease in the rigidity of the reinforcing member is prevented, as compared with multiple through void portions penetrating through the reinforcing member such as the frame 3.

### Aspect 5

In the liquid discharge head of Aspect 4, the one through void portion 3b-1 penetrating through the reinforcing member such as the frame 3 is disposed at the center in the longitudinal direction of the liquid discharge head 1.

In other words, the through void portion is disposed at a center of the frame in the longitudinal direction.

With this configuration, as described in the second example, well-balanced rigidity of the reinforcing member such as the frame 3 is obtained.

### Aspect 6

In the liquid discharge head of Aspect 5, the through void portion 3b-1 is filled with the sealant 3c for sealing an electric component such as the thermistor 29 exposed from the through void portion 3b-1.

In other words, the liquid discharge head according to Aspect 5, further includes an electric component attached to the actuator component, facing the through void portion and a sealant filling the through void portion to seal the electric component in the through void portion.

With this configuration, as described in the second example, an electric component such as the thermistor 29 is protected from, for example, moisture.

### Aspect 7

In the liquid discharge head of Aspect 6, the sealant 3c on a side near the substrate component such as the actuator component 2 is in an uncured state.

In other words, a portion of the sealant adjacent to the actuator component is uncured.

With this configuration, as described in the second example, stress due to contraction of the sealant 3c that has been cured on the side near the substrate component is prevented from being applied to the substrate component to reduce an influence on the discharging performance.

### Aspect 8

In the liquid discharge head of any one of Aspects 4 to 7, the depth L2 of each of the void portions 3b-2 each having the recess in cross section is equal to or greater than ⅓ of the length L1 of the reinforcing member such as the frame 3 in the vertical direction perpendicular to the bonding face 3d.

In other words, a depth of each of the recesses is equal to or greater than ⅓ of a length of the frame in the discharge direction.

With this configuration, as described in the second example, thermal contraction on the side near the bonding face 3d of the reinforcing member such as the frame 3 is satisfactorily reduced, and the deterioration of the liquid discharging performance due to the thermal stress applied to the substrate component such as the actuator component 2 is prevented.

### Aspect 9

A liquid discharge head such as the liquid discharge head 1 includes a substrate component and a reinforcing member. The substrate component such as the actuator component 2 includes the diaphragm 22 and the piezoelectric elements 23. The diaphragm 22 is laminated on a substrate such as the pressure chamber substrate 21 formed with liquid chambers such as the pressure chambers 21b communicating with nozzles such as the nozzle holes 10a. The diaphragm 22 forms part of wall surfaces of the liquid chambers. The piezoelectric elements 23 are laminated on a surface of the diaphragm 22 on a side opposite a side forming the wall surfaces of the liquid chambers. The reinforcing member such as the frame 3 has communicating portions such as the communicating holes 3a communicating with the liquid chambers. The reinforcing member is bonded to the substrate component with the adhesive 50. The reinforcing member has a void portion including a recess in cross section or a closed void portion.

In other words, a liquid discharge head includes an actuator component and a frame. The actuator component includes a nozzle substrate and an actuator substrate. The nozzle substrate has nozzles arrayed in a longitudinal direction of the nozzle substrate. The actuator substrate includes a chamber substrate, a diaphragm, and a piezoelectric element. The chamber substrate is disposed over the nozzle substrate. The chamber substrate has pressure chambers respectively communicating with the nozzles. The diaphragm is disposed over the chamber substrate. The diaphragm has a first face serving as a part of a wall face of the pressure chambers and a second face opposite the first face. The piezoelectric element is disposed over the second face of the diaphragm, to discharge a liquid in the pressure chambers from the nozzles in a discharge direction orthogonal to the longitudinal direction. The frame has a bonding face bonded to the actuator component with an adhesive, communicating portions communicating with the pressure chambers, and a void portion including a recess (or including a closed space).

With this configuration, as described in the third example, the substrate component is satisfactorily reinforced by the reinforcing member, and the deformation of the substrate component due to an external force is prevented, as compared with a frame-shaped reinforcing member having a void portion which is a large through hole disposed at the center.

The multiple void portions 3b reduce the volume of the reinforcing member. Accordingly, the amount of thermal contraction of the reinforcing member is reduced when the reinforcing member returns to the room temperature after the reinforcing member and the substrate component are bonded to each other. As a result, the thermal stress applied to the substrate component is reduced, and a change in the rigidity of the diaphragm 22 and the piezoelectric elements 23 is reduced, to prevent the deterioration in the liquid discharging performance.

### Aspect 10

In the liquid discharge head of Aspect 9, at least one of a region in which a cross-sectional area of the cross section, which is perpendicular to an orthogonal direction orthogonal to both the arrangement direction of the nozzles and a liquid discharge direction of the nozzles, of the void portion monotonously increases from one end to the other end in the arrangement direction of the nozzles or a region in which the cross-sectional area monotonously decreases from the one end to the other end in the arrangement direction of the nozzles is included.

In other words, the void portion has a cross-sectional area on a plane orthogonal to the longitudinal direction, and the cross-sectional area has a distribution in the longitudinal direction. The distribution includes at least one of a first region in which the cross-sectional area increases in a direction from a first end of the frame toward a second end opposite the first end of the frame in the longitudinal direction or a second region in which the cross-sectional area decreases in the direction from the first end toward the second end in the longitudinal direction.

As described in the third example, multiple substrates (e.g., the actuator substrates 20) for the substrate component such as the actuator component 2 are formed on the piezoelectric element wafer 100. For example, an error in thickness of the diaphragm is generated concentrically on the piezoelectric element wafer 100. As a result, the substrate (e.g., the actuator substrate 20) formed at an end of the piezoelectric element wafer 100 is likely to have a region in which the discharge speed of the liquid from the nozzles monotonously increases or monotonously decreases from the one end to the other end in the nozzle arrangement direction due to characteristics such as the error in thickness of the diaphragm.

In the nozzle arrangement direction, when the amount of thermal contraction of the reinforcing member such as the frame 3 is large, the diaphragm 22 at that location is compressed to be loosened. Since the diaphragm 22 is loosened, the displacement amount of the piezoelectric element 23 at that location becomes larger than when the diaphragm 22 is tensioned, and thus the discharge speed at that location is increased.

As the cross-sectional area of the cross section, which is perpendicular to the orthogonal direction orthogonal to both the arrangement direction of the nozzles and the liquid discharge direction of the nozzles, of the void portion becomes narrower, the volume of the reinforcing member at that location increases, and the amount of thermal contraction of the reinforcing member increases. As a result, the diaphragm 22 is largely loosened, and the discharge speed at that location is increased. In the nozzle arrangement direction, as the cross-sectional area of the void portion monotonically increases from the one end to the other end in the nozzle arrangement direction, the discharge speed monotonously decreases due to thermal contraction of the reinforcing member. On the other hand, in the nozzle arrangement direction, as the cross-sectional area of the void portion monotonically decreases from the one end to the other end in the nozzle arrangement direction, the discharge speed monotonously increases due to thermal contraction of the reinforcing member.

When the discharge speed monotonously increases from the one end to the other end in the nozzle arrangement direction in a region due to the characteristics of the substrate (e.g., the actuator substrate 20) of the substrate component, the cross-sectional area monotonously decreases from the one end to the other end in the same region to prevent variations in the discharge speed due to the characteristics of the substrate (e.g., the actuator substrate 20) of the substrate component. When the discharge speed monotonously decreases from the one end to the other end in the nozzle arrangement direction in a region due to the characteristics of the substrate (e.g., the actuator substrate 20) of the substrate component, the cross-sectional area monotonously increases from the one end to the other end in the same region to prevent variations in the discharge speed due to the characteristics of the substrate (e.g., the actuator substrate 20) of the substrate component.

As described above, the void portion having a distribution including at least one of a region in which the cross-sectional area monotonically increases or a region in which the cross-sectional area monotonically decreases from the one end to the other end in the nozzle arrangement direction can reduce variations in the discharge speed due to the characteristics of the substrate (e.g., the actuator substrate 20) of the substrate component.

### Aspect 11

In the liquid discharge head of Aspect 10, a region in which the cross-sectional area of the void portion 3b is constant in the arrangement direction of the nozzles is included.

In other words, the distribution further includes a third region in which the cross-sectional area is constant in the longitudinal direction.

With this configuration, as described with reference to FIGS. 11A, 11B, 14A, 14B, and other drawings, the void portion has the constant cross-sectional area in the nozzle arrangement direction in the region in which the discharge speed is substantially constant in the nozzle arrangement direction due to the characteristics of the substrate (e.g., the actuator substrate 20) of the substrate component. Such a configuration prevents variations in the discharge speed due to an influence of the void portion in the region in which the discharge speed distribution is even in the nozzle arrangement direction due to the characteristics of the substrate (e.g., the actuator substrate 20) of the substrate component.

### Aspect 12

In the liquid discharge head of Aspect 10, the cross-sectional area of the void portion 3b monotonically increases or monotonically decreases from one end to the other end in the arrangement direction.

In other words, the distribution includes either the first region or the second region.

With this configuration, when the discharge speed monotonously increases or monotonously decreases from the one end to the other end in the nozzle arrangement direction due to the characteristics of the substrate (e.g., the actuator substrate 20) of the substrate component, variations in the discharge speed can be reduced.

### Aspect 13

In the liquid discharge head of any one of Aspects 9 to 12, the void portion 3b overlaps a region in which the piezoelectric element 23 is disposed on the substrate component (e.g., the actuator component 2) as viewed in the liquid discharge direction.

In other words, the void portion overlaps a region in which the piezoelectric element is disposed in the discharge direction.

With this configuration, as described in the third example, the amount of contraction of the substrate component (e.g., the actuator component 2) at that location can be satisfactorily controlled by the shape (cross-sectional area) of the void portion 3b. Accordingly, variations in the discharge speed due to the characteristics of the actuator substrate 20 can be satisfactorily reduced by the shape (cross-sectional area) of the void portion 3b.

### Aspect 14

In the liquid discharge head of any one of Aspects 9 to 13, the void portion 3b has a recess in cross section. The recess has an opening on the face 3f of the reinforcing member, such as the frame 3, opposite the bonding face 3d to which the substrate component is bonded.

In other words, the recess of the void portion has an opening on a face of the frame opposite the bonding face.

With this configuration, as described in the third example, the thermal stress due to a difference in the amount of thermal contraction with respect to the reinforcing member (e.g., the frame 3) is satisfactorily applied to the substrate component (e.g., the actuator component 2) to satisfactorily control the amount of contraction of the substrate component (e.g., the actuator component 2) at that location. Accordingly, variations in the discharge speed due to the characteristics of the actuator substrate 20 can be satisfactorily reduced by the shape (cross-sectional area) of the void portion 3b.

The degree of freedom in layout of the channels in the substrate component can be increased. Further, a decrease in the bonding area between the substrate component and the frame 3 is prevented to prevent a decrease in the sealability.

### Aspect 15

In the liquid discharge head of any one of Aspects 1 to 14, the linear expansion coefficient of the substrate component such as the actuator component 2 is smaller than the linear expansion coefficient of the reinforcing member such as the frame 3, and the adhesive 50 is a thermosetting adhesive.

In other words, a linear expansion coefficient of the actuator component is smaller than a linear expansion coefficient of the frame, and the adhesive is a thermosetting adhesive.

With this configuration, thermal contraction of the reinforcing member such as the frame 3 is reduced when the reinforcing member returns to the room temperature after the adhesive is thermally cured, the thermal stress applied to the substrate component such as the actuator component 2 is reduced, and the deterioration of the discharging performance is prevented.

### Aspect 16

A liquid discharge apparatus includes a liquid discharge head, and the liquid discharge head according to any one of Aspects 1 to 15 is used as the liquid discharge head.

In other words, a liquid discharge apparatus includes the liquid discharge head according to Aspects 1 to 15, to discharge the liquid onto a medium and a conveyor to convey the medium to the liquid discharge head.

With this configuration, liquid is satisfactorily discharged.

According to one aspect of the present disclosure, the deterioration of the liquid discharging performance can be prevented.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
an actuator component including:
a nozzle substrate having nozzles arrayed in a longitudinal direction of the nozzle substrate; and
an actuator substrate including:
a chamber substrate over the nozzle substrate, the chamber substrate having pressure chambers respectively communicating with the nozzles;
a diaphragm over the chamber substrate, the diaphragm having:
a first face serving as a part of a wall face of the pressure chambers; and
a second face opposite the first face; and
a piezoelectric element over the second face of the diaphragm, to discharge a liquid in the pressure chambers from the nozzles in a discharge direction orthogonal to the longitudinal direction; and
a frame having:
a bonding face bonded to the actuator component with an adhesive;
communicating portions communicating with the pressure chambers; and
multiple void portions.

2. The liquid discharge head according to claim 1,
wherein the multiple void portions are arranged in the longitudinal direction.

3. The liquid discharge head according to claim 1,
wherein the multiple void portions have openings on the bonding face of the frame.

4. The liquid discharge head according to claim 3,
wherein, a part of the multiple void portions has a through void portion penetrating through the frame, and
other part of the multiple void portions has recesses recessed from the bonding face of the frame.

5. The liquid discharge head according to claim 4,
wherein the through void portion is disposed at a center of the frame in the longitudinal direction.

6. The liquid discharge head according to claim 5, further comprising:
an electric component attached to the actuator component, facing the through void portion; and
a sealant filling the through void portion to seal the electric component in the through void portion.

7. The liquid discharge head according to claim 6,
wherein a portion of the sealant adjacent to the actuator component is uncured.

8. The liquid discharge head according to claim 4,
wherein a depth of each of the recesses is equal to or greater than ⅓ of a length of the frame in the discharge direction.

9. A liquid discharge head comprising:
an actuator component including:
a nozzle substrate having nozzles arrayed in a longitudinal direction of the nozzle substrate; and
an actuator substrate including:
a chamber substrate over the nozzle substrate, the chamber substrate having pressure chambers respectively communicating with the nozzles;
a diaphragm over the chamber substrate, the diaphragm having:
a first face serving as a part of a wall face of the pressure chambers; and
a second face opposite the first face; and
a piezoelectric element over the second face of the diaphragm, to discharge a liquid in the pressure chambers from the nozzles in a discharge direction orthogonal to the longitudinal direction; and
a frame having:
a bonding face bonded to the actuator component with an adhesive;
communicating portions communicating with the pressure chambers; and
a void portion having a recess.

10. The liquid discharge head according to claim 9,
wherein the void portion has a cross-sectional area on a plane orthogonal to the longitudinal direction, and
the cross-sectional area has a distribution in the longitudinal direction, the distribution including at least one of:
a first region in which the cross-sectional area increases in a direction from a first end of the frame toward a second end opposite the first end of the frame in the longitudinal direction; or
a second region in which the cross-sectional area decreases in the direction from the first end toward the second end in the longitudinal direction.

11. The liquid discharge head according to claim 10,
wherein the distribution further includes a third region in which the cross-sectional area is constant in the longitudinal direction.

12. The liquid discharge head according to claim 10,
wherein the distribution includes either the first region or the second region.

13. The liquid discharge head according to claim 9,
wherein the void portion overlaps a region in which the piezoelectric element is disposed in the discharge direction.

14. The liquid discharge head according to claim 9,
wherein the recess of the void portion has an opening on a face of the frame opposite the bonding face.

15. The liquid discharge head according to claim 1,
wherein a linear expansion coefficient of the actuator component is smaller than a linear expansion coefficient of the frame, and
the adhesive is a thermosetting adhesive.

16. A liquid discharge apparatus comprising:
the liquid discharge head according to claim 1, to discharge the liquid onto a medium; and
a conveyor to convey the medium to the liquid discharge head.

17. A liquid discharge head comprising:
an actuator component including:
a nozzle substrate having nozzles arrayed in a longitudinal direction of the nozzle substrate; and
an actuator substrate including:
a chamber substrate over the nozzle substrate, the chamber substrate having pressure chambers respectively communicating with the nozzles;
a diaphragm over the chamber substrate, the diaphragm having:
a first face serving as a part of a wall face of the pressure chambers; and
a second face opposite the first face; and
a piezoelectric element over the second face of the diaphragm, to discharge a liquid in the pressure chambers from the nozzles in a discharge direction orthogonal to the longitudinal direction; and
a frame having:
a bonding face bonded to the actuator component with an adhesive;
communicating portions communicating with the pressure chambers; and
a void portion including a closed space.
